(19) United States
(12) Patent Application Publication
(10) Pub. No.: US 2024/0248477 A1
(43) Pub. Date: Jul. 25, 2024

(54) MULTI-DRONE BEYOND VISUAL LINE OF SIGHT (BVLOS) OPERATION

(71) Applicant: Uri WEINHEBER, Matan (IL)

(72) Inventor: Uri WEINHEBER, Matan (IL)

(21) Appl. No.: 18/289,231

(22) PCT Filed: May 2, 2022
(86) PCT No.: PCT/IL2022/050456

§ 371 Date: Nov. 2, 2023

Related U.S. Application Data
(60) Provisional application No. 63/183,081, filed on May 3, 2021.
(60) Provisional application No. 63/271,263, filed on Oct. 25, 2021.

(51) Int. Cl. G05D 1/224; G05D 1/248; G05D 1/622; G05D 1/654; G05D 1/69; G05D 1/86; G05D 101/15; G05D 109/20; G05D 111/10; G06T 7/20; G06T 7/70

(52) U.S. Cl. CPC G05D 1/2247; G05D 1/248; G05D 1/622; G05D 1/6546; G05D 1/69; G05D 1/86; G06T 7/20; G06T 7/70; G05D 2101/15; G05D 2109/20; G05D 2111/10; G06T 2207/10032; G06T 2207/20081; G06T 2207/30261

(57) ABSTRACT

Disclosed herein are methods and systems for operating drones beyond visual line of sight (BVLOS), comprising receiving a first image stream captured by one or more imaging sensors mounted on a first drone and operated to monitor a companion second drone flying within visual line of sight of the first drone, receiving a second image stream captured by one or more imaging sensors mounted on the second drone and operated to monitor the first drone flying within visual line of sight of the second drone, operating the second drone based on analysis of the first image stream in which the second drone and its vicinity are continuously tracked, and operating the first drone based on analysis of the second image stream in which the first drone and its vicinity are continuously tracked.

### RELATED APPLICATIONS

This application claims the benefit of priority under 35 USC § 119(e) of U.S. Provisional Patent Application No. 63/183,081 filed on May 3, 2021, and U.S. Provisional Patent Application No. 63/271,263 filed on Oct. 25, 2021. The contents of the above applications are all incorporated by reference as if fully set forth herein in their entirety.

### BACKGROUND

The present invention, in some embodiments thereof, relates to operating drones Beyond Visual Line of Sight (BVLOS), and, more specifically, but not exclusively, to operating BVLOS each of a group of drones flying in companion in Visual Line of Sight (VLOS) with each other according to image streams captured by the companion drone(s).

Recent years have witnessed constant advancements in drone technology, for example, increased range, improved reliability, advanced control and/or the like which inevitably leads to increased availability of cost effective drone solutions.

As result a wide and diverse range of commercial and/or recreational drone based applications, systems and services has become wide spread and highly accessible, for example, drone automated delivery services, public order systems, security systems, surveillance systems and agriculture related applications to name just a few.

However, with the rapid increase of drone use, regulatory directives and rules have been put into effect in most countries in order to ensure safe and reliable operation of the drones such that the drones may not pose a threat to themselves and moreover to their surrounding environment, in particular to prevent potential damage, injury and/or fatalities to people.

### SUMMARY

It is an object of the present invention to provide, methods, systems and software program products for operating drones BVLOS of an operator according to imagery data captured by companion drones. The foregoing and other objects are achieved by the features of the independent claims. Further implementation forms are apparent from the dependent claims, the description and the figures.

According to a first aspect of the present invention there is provided a computer implemented method of operating drones BVLOS, comprising:
Receiving a first image stream captured by one or more imaging sensors mounted on a first drone and operated to monitor a companion second drone flying within visual line of sight of the first drone.
Receiving a second image stream captured by one or more imaging sensors mounted on the second drone and operated to monitor the first drone flying within visual line of sight of the second drone.
Operating the second drone based on analysis of the first image stream in which the second drone and its vicinity are continuously tracked.
Operating the first drone based on analysis of the second image stream in which the first drone and its vicinity are continuously tracked.

According to a second aspect of the present invention there is provided a system for operating drones BVLOS, comprising one or more processors executing a code. The code comprising:
Code instructions to receive a first image stream captured by one or more imaging sensors mounted on a first drone and operated to monitor a companion second drone flying within visual line of sight of the first drone.
Code instructions to receive a second image stream captured by one or more imaging sensors mounted on the second drone and operated to monitor the first drone flying within visual line of sight of the second drone.
Code instructions to operate the second drone based on analysis of the first image stream in which the second drone and its vicinity are continuously tracked.

Code instructions to operate the first drone based on analysis of the second image stream in which the first drone and its vicinity are continuously tracked.

According to a third aspect of the present invention there is provided a computer implemented method of selecting and operating groups of drones in missions extending BVLOS, comprising:
Receiving a plurality of missions each associated with a respective one of a plurality of drones.
Analyzing a plurality of mission parameters of the plurality of missions and a plurality of drone operational parameters of the plurality of drones.
Selecting one or more groups each comprising two or more of the plurality of drones based on one or more of the plurality of mission parameters of the mission of each of the two or more drones and one or more of the plurality of drone operational parameters of each of the two or more drones. The two or more drones are grouped to fly in companion in visual line of sight of each other.
Operating each of the two or more drones based on analysis of an image stream captured by one or more imaging sensors mounted on another one of the two or more drones.

According to a fourth aspect of the present invention there is provided a system for selecting and operating groups of drones in missions extending BVLOS, comprising one or more processors executing a code. The code comprising:
Code instructions to receive a plurality of missions each associated with a respective one of a plurality of drones.
Code instructions to analyze a plurality of mission parameters of the plurality of missions and a plurality of drone operational parameters of the plurality of drones.
Code instructions to select one or more groups each comprising two or more of the plurality of drones based on one or more of the plurality of mission parameters of the mission of each of the two or more drones and one or more of the plurality of drone operational parameters of each of the two or more drones. The at least two drones are planned to fly in companion in visual line of sight of each other.
Code instructions to operate each of the at least two drones based on analysis of an image stream captured by one or more imaging sensor mounted on another one of the two or more drones.

In an optional implementation form of the first and/or second aspects, one or more other drones are operated according to one or more image streams depicting the one or more other drones which is captured by one or more of: the one or more imaging sensors of the first drone, the one or more imaging sensors of the second drone, and one or more imaging sensors of the one or more other drones such that each drone is depicted in one or more image stream.

In a further implementation form of the first, second, third and/or fourth aspects, the first drone, the second drone and/or the two or more drones are operated in one or more of: an outdoor environment, and an indoor environment.

In a further implementation form of the first, second, third and/or fourth aspects, the first drone, the second drone and/or the two or more drones are operated by one or more of, manually by one or more operators at a remote control system, automatically by one or more control units deployed at the remote control system, automatically by a remote server in communication with to the remote control system, automatically by one or more control units deployed at the respective drone, and/or automatically by one or more control units deployed in the other drone.

In an optional implementation form of the first and/or second aspects, one or more annotated image streams are generated based on the analysis of the first image stream and/or the second image stream, the one or more annotated image streams comprising additional visual data relating to one or more objects identified in the respective image stream.

In an optional implementation form of the first and/or second aspects, one or more alerts are generated in response to detecting one or more events relating to the first drone and/or the second drone.

In an optional implementation form of the first and/or second aspects, the one or more alerts are generated in response to detecting one or more objects in the first image stream and/or in the second image stream.

In an optional implementation form of the first and/or second aspects, the one or more alerts are generated in response to detecting a deviation of the first drone and/or the second drone from a predefined route.

In an optional implementation form of the first and/or second aspects, correct route instructions are transmitted to the deviating drone.

In an optional implementation form of the first and/or second aspects, the one or more alerts are generated in response to detecting one or more malfunctions to the first drone and/or the second drone detected in the second image stream and/or in the first image stream respectively.

In an optional implementation form of the first and/or second aspects, one or more of the alerts are transmitted to one or more Unmanned Aircraft System Traffic Management (UTM) systems.

In a further implementation form of the first and/or second aspects, the first drone and/or second drone are operated to avoid one or more obstacles in a potential collision course with the first drone and/or second drone based on analysis of the second image stream and/or in the first image stream respectively.

In an optional implementation form of the first and/or second aspects, one or more alerts are generated in response to detecting one or more obstacles.

In a further implementation form of the first and/or second aspects, one or more of the alerts are transmitted to one or more UTM systems.

In an optional implementation form of the first and/or second aspects, the first image stream and/or the second image stream are further analyzed to identify at least one attribute of the at least one obstacle, the at least one attribute is a member of a group consisting of: an obstacle type, a location, a velocity and a heading.

In an optional implementation form of the first and/or second aspects, landing of the first drone and/or the second drone at a landing site is assisted by analyzing a respective image stream depicting the landing drone and its vicinity to identify one or more potential obstacles en route to the landing site and/or in the landing site.

In an optional implementation form of the first and/or second aspects, one or more landings of the first drone and/or the second drone are managed according to a landing protocol in which the landing drone is escorted by its companion drone using a predefined protocol defining a position of the companion drone relative to the landing drone at every stage of the landing.

In an optional implementation form of the first and/or second aspects, delivery of at least one package by the first drone and/or the second drone is assisted by analyzing a respective image stream depicting the delivering drone and its vicinity to identify one or more potential obstacles en route to the delivery site and/or at the delivery site.

In a further implementation form of the first and/or second aspects, the first drone and/or second drone are operated in case of a malfunction condition to the first drone and/or second drone. In an optional implementation form of the first and/or second aspects, a respective image stream depicting the malfunctioning drone is automatically analyzed to identify one or more potential emergency landing sites, and a route for the malfunctioning drone to a selected one of the one or more potential emergency landing sites.

In an optional implementation form of the first and/or second aspects, the malfunctioning drone is operated to open a parachute and drop in a drop zone after determining, based on analysis of the respective image stream, the drop zone is clear.

In an optional implementation form of the first and/or second aspects, a position of the first drone and/or the position of the second drone with respect to each other is dynamically adjusted according to one or more visibility attributes to maintain the line of sight between the first drone and the second drone, the one or more visibility attributes are imposed by one or more of: an object potentially blocking the line of sight, and an environmental condition reducing visibility range.

In a further implementation form of the first and/or second aspects, the first drone and/or the one or more imaging sensors of the first drone are operated based on analysis of the first image stream to track the second drone around a center of a field of view (FOV) of the one or more imaging sensors of the first drone. Moreover, the second drone and/or the one or more imaging sensors of the second drone are operated based on analysis of the second image stream to track the first drone around a center of a FOV of the one or more imaging sensors of the second drone.

In a further implementation form of the first and/or second aspects, the one or more sensors are members of a group consisting of: a camera, a video camera, a thermal camera, an infrared camera, a night vision sensor, a depth camera, a ranging sensor, a Laser imaging, Detection and Ranging (LiDAR), and a Radio Detection and Ranging (RADAR).

In a further implementation form of the first and/or second aspects, the first drone and the second drone communicate with a remote control system via one or more communication channels.

In a further implementation form of the first and/or second aspects, one of the first drone and/or the second drone communicating with each other via one or more drone-to-drone communication channels serves as a relay for its companion drone to communicate with the remote control system. In an optional implementation form of the first and/or second aspects, a position of the first drone is computed based on a position of the second drone and a relative position of the first drone with respect to the second drone as derived from analysis of the second image stream, or vice versa a position of the second drone is computed based on a position of the first drone and a relative position of the second drone with respect to the first drone as derived from analysis of the first image stream.

In an optional implementation form of the first and/or second aspects, the computed position of the first drone is transmitted to the first drone and/or the computed position of the second drone is transmitted to the second drone.

In an optional implementation form of the first and/or second aspects, a position of the first drone and/or the position of the second drone with respect to each other is dynamically adjusted in order to ensure one or more of the first drone and the second drone have global navigation satellite system (GNSS) signal.

In an optional implementation form of the first and/or second aspects, a position of the first drone and/or the position of the second drone with respect to each other is dynamically adjusted in order to support visual navigation of one or more of the first drone and the second drone.

In an optional implementation form of the first and/or second aspects, one or more flight parameters of one of the first drone and/or the second drone are computed based on deriving them from analysis of the second image stream and/or the first image stream respectively. The one or more flight parameter are members of a group consisting of: a speed, an altitude, a direction, and an orientation.

In an optional implementation form of the first and/or second aspects, one or more flight parameters are computed based on sensory data fusion between visual data extracted from the first and/or second image streams and telemetry data received from the first and/or second drones.

In an optional implementation form of the first and/or second aspects, the first drone and/or the second drone are tracked using one or more prediction algorithms applied to predict a position of the first drone and/or the second drone based on detection of the first drone and/or the second drone in periodically selected images of the second image stream and/or the first image stream respectively.

In an optional implementation form of the first and/or second aspects, the first drone and/or the second drone are detected and tracked using one or more Machine Learning (ML) models trained to predict the position of the first drone and/or of the second drone based on a flight pattern of the first drone and/or of the second drone respectively identified based on analysis of the second image stream and/or the first image stream respectively.

In an optional implementation form of the first and/or second aspects, the first drone is operated as a supervisor drone to monitor a plurality of subordinate drones and their vicinities. Each of the plurality of subordinate drones is operated based on analysis of the first image stream captured by the one or more imaging sensors of the first drone in which the respective drone is continuously tracked. The first drone is operated based on analysis of one or more image streams captured by one or more imaging sensors mounted on one or more of the plurality of subordinate drones and operated to monitor the first drone.

In an optional implementation form of the first and/or second aspects, the one or more imaging sensors of the first drone and/or the one or more imaging sensors of the second drone are mounted on one or more arms extending from the first drone and/or the second drone respectively such that the first image stream further depicts the first drone and/or the second image stream depicts the second drone.

In an optional implementation form of the first and/or second aspects the first image stream and/or the second image stream are captured by one or more stationary imaging sensors deployed statically to a monitored flight area of the first drone and/or the second drone.

In a further implementation form of the third and fourth aspects, the plurality of mission parameters are members of a group consisting of: a mission type, a geographical area, a destination, a route, a duration, and a schedule.

In a further implementation form of the third and fourth aspects, the plurality of drone operational parameters are members of a group consisting of: a speed, a flight range, an altitude, a power consumption, a battery capacity, a resolution of the one or more imaging sensors, a Field of View (FOV) of the one or more imaging sensors, and a range of the one or more imaging sensors.

In an optional implementation form of the third and fourth aspects, one or more of the groups are selected according to one or more of a plurality of optimization criteria. The plurality of optimization criteria are members of a group consisting of: a minimal mission duration, an earliest mission completion, a minimal mission power consumption, a minimal mission cost, and a minimal turn-around time for the next mission.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks automatically. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of methods and/or systems as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars are shown by way of example and for purposes of illustrative discussion of embodiments of the invention. In this regard, the description taken with the drawings makes apparent to those skilled in the art how embodiments of the invention may be practiced.

In the drawings:

FIG. 1 is a flowchart of an exemplary process of operating each of a group of drones flying in companion having VLOS with each other according to an image stream captured by one or more of the companion drones, according to some embodiments of the present invention;

FIG. 2A and FIG. 2B are schematic illustrations of an exemplary system for operating each of a group of drones flying in companion having VLOS with each other according to an image stream captured by one or more of the companion drones, according to some embodiments of the present invention;

FIG. 3A, FIG. 3B and FIG. 3C are schematic illustrations of exemplary drone flight formations employed to maintain VLOS between companion drones in order to operate the drones based on image streams captured by their companion drones, according to some embodiments of the present invention;

FIG. 4 is a flowchart of an exemplary process of selecting groups of drones for flying in companion in VLOS with each other and operating the group of drones according to image streams captured by companion drones, according to some embodiments of the present invention; and

FIG. 5 is a schematic illustration of an exemplary system for selecting groups of drones for flying in companion in VLOS with each other and operating the group of drones according to image streams captured by companion drones, according to some embodiments of the present invention.

### DETAILED DESCRIPTION

The present invention, in some embodiments thereof, relates to operating drones BVLOS, and, more specifically, but not exclusively, to operating BVLOS each of a group of drones flying in companion in VLOS with each other according to image streams captured by the companion drone(s).

According to some embodiments of the present invention, there are provided methods, systems and computer program products for operating multiple drones flying in companion in Visual Line of Sight (VLOS) of each other according to image streams captured by one or more of the drones which depict their companion drones. Drones as addressed and described throughout this disclosure include practically any Aerial Unmanned Vehicle (UAV), including Urban Air Mobility (UAM) vehicles whether currently available or introduced in the future. Such UAVs, encompassed by the term drones, may be characterized by different parameters (e.g. size, flight altitude, maneuverability, etc.) and may be operated for a variety of applications, utilities and/or missions.

Moreover, the BVLOS operation described herein after for drones (i.e., UAVs) may be further expanded and applied for operating other non-aerial autonomous vehicles BVLOS, for example, ground vehicles and/or naval vehicles.

In particular, multiple drones may be grouped together in one or more groups each comprising two or more drones operated to fly in companion such that while one or more of the drones of the group may be Beyond Visual Line of Sight (BVLOS) of their operator(s) and/or their remote control system, each of the drones of the group may be VLOS with at least one another one of the other drones of the group. The drones flying in companion in VLOS with each other may therefore monitor each other and capture images stream depicting their companion drone(s) thus forming what may be designated Digital Line of sight (DLOS) which may be used to operate the drones while BVLOS of their operator(s) and/or remote control system(s).

The remote control system which may be ground based and/or airborne, may include, for example, a Ground Control Station (GCS), specifically a UAV GCS, an Unmanned Aircraft System Traffic Management (UTM), and/or the like.

The drones grouped to fly in companion in indoor, outdoor and/or combined environments may be operated to fly in one or more of a plurality of flight formations to ensure that each of the drones of the group is in VLOS with at least another one of the other drones of the group. The flight formations may include, for example, pair formation in which each of the two drones may be in VLOS with its paired drone. In another example, a cyclic formation may be applied for groups comprising three or more drones which may each be in VLOS with its neighbor (adjacent) drone. In another example, a multi-companion and/or platoon formation may be applied for groups comprising three or more drones where one of the drones may be in VLOS with multiple other drones of the group.

Each of the drones may typically have one or more imaging sensors, for example, a camera, a video camera, a thermal imaging camera, an Infrared sensor, a depth camera, a Laser Detection and Ranging (LiDAR) sensor, a Radio Detection and Ranging (RADAR) sensor and/or the like mounted, attached, integrated and/or otherwise mechanically coupled to the drone.

The drones of the group may monitor each other and may capture imagery data and/or other sensory data, for example, images streams, ranging maps, thermal maps and/or the like, designated image streams herein after, depicting the other (companion) drone(s) of the group. Specifically, each drone of the group may be monitored by at least one of the other drones of the group and may be therefore depicted in at least one image stream.

The drones communicating with the remote control system and optionally with each other may transmit the captured image streams depicting their companion drone(s) and the vicinity of their companion drone(s) which may be analyzed and used to operate the drones accordingly. Actively operating the drones may be typically done in situations of emergency and/or malfunction to the drones while during normal conditions the drones may typically operate autonomously according to predefined mission plans.

Operating the drones of the group may be done in several automation levels. For example, in its basic operation mode, one or more of the drones of the group may be manually operated by one or more operators presented with the respective image streams depicting the respective drone(s).

However, in more advanced operation modes, one or more of the image stream depicting one or more of the drones and at least some of their surrounding flight space may be automatically analyzed to further support the operator(s). For example, one or more of the image streams may be analyzed to detect the drone(s) in one or more images extracted from respective image stream(s) and optionally track the position (location) (e.g. longitude, latitude, altitude, etc.) of respective drone(s) in consecutive images. In another example, one or more of the image streams may be analyzed to support collision avoidance and identify one or more objects, potential obstacles and/or the like which may be in a collision course with the drone(s). The images may be further analyzed to identify one or more attributes of one or more of the detected obstacles, for example, an obstacle type, a location, a velocity, a heading (movement vector) and/or the like. In another example, one or more of the image streams may be analyzed to identify indications of potential damage and/or malfunction of the drone(s), for example, damage signs on the drone's body exterior, rotor(s) failure, smoke signs and/or the like. In another example, one or more of the image streams may be analyzed to identify one or more visibility and/or environmental conditions (e.g. day, night, dusk, clouds, fog, smog, rain, hail, snow, etc.).

The operator(s) at the remote control system(s) may be thus presented with one or more annotated image streams may be generated to enhance the image stream(s) with further visual detail, for example, symbols, text, icons, bounding boxes, tracked paths and/or the like marking one or more objects and/or elements, for example, the drone(s), other drone(s), potential obstacles, in proximity objects, in collision course objects and/or the like. Moreover, one or more visual and/or audible alerts may be generated to alert the operator(s) in case of detected emergency, malfunction and/or potential obstacle that may be in collision course with the drone(s).

Optionally, tracking one or more of the drones in their respective image stream may be done based on prediction rather than actually analyzing each image to detect the drone(s). The position of the drone(s) may be predicted based on its position detected in one or more previous images of its respective image stream(s), for example, periodically extracted images. Predicting the drones' position may be done using one or more prediction methods, algorithms and/or models, for example, statistical model, machine learning models and/or the like which may be configured, adapted and/or trained to predict the position of drones based on their previous positions and/or identified flight pattern.

Optionally, the route (i.e., path, course, waypoints, etc.) and/or one or more flight parameters (e.g. speed, altitude, etc.) of one or more of the drones may be monitored in the image stream(s) depicting the respective drone(s) and compared to predefined route and/or flight parameters as defined by the mission plan of the respective drone(s) and alert(s) may be generated in case a deviation is detected. Moreover, one or more of the drones may store the predefined route of their companion drone(s) and in case the drone(s) detect such a deviation in the route of their companion drone(s), the drone(s) may transmit the correct route instructions to their companion drone(s), for example, waypoint, dead reckoning navigation instructions and/or the like. The correct route instructions delivered to the deviating drone(s) may be based on the position and/or location of their companion drone(s).

Optionally, the distance between two drones may be estimated based on analysis of the respective image stream. Moreover, the heading and/or direction of one or more of the drones relative to its companion drone may be also estimated based on the analysis of the respective image stream.

Optionally, the position of one or more of the drones flying in companion may be computed based on the relative position of the respective drone compared to its companion drone which monitors it and captures the image stream depicting the receptive drone. In particular, the position of the respective drone may be computed based on the absolute position of its companion drone which may be derived from one or more sources, for example, a Global Navigation Satellite System (GNSS) (e.g. Global Positioning System (GPS), etc.) sensor and/or the like combined with the relative position of the receptive drone with respect to the companion drone as derived from analysis of the image stream. Moreover, the computed position of the receptive drone may be transmitted to the receptive drone.

Optionally, since the position of each drone (absolute position and relative to its companion drone) is known, the image streams collected at the remote control system(s) may be used to update one or more maps, in particular 3D maps of the flight route with the identified obstacles optionally coupled with one or more of their attributes, for example, location, velocity, heading and/or the like thus generating a live update of the map employed to design and control the flight route.

As the drone(s) may be typically operated in case of emergency, emergency landing may be applied to land one or more of the drone(s) in emergency landing sites. The image stream(s) depicting the emergency landing drone(s) may be therefore analyzed to identify one or more potential landing sites and route(s) to the landing site(s) as well as potential obstacles and/or hazards to the emergency landing drone(s), for example, potential obstacles en route to the landing sites and/or on the ground. Moreover, in case a parachute has to be used to prevent a crash, the command to activate the parachute may be issued only after analysis of the image stream captured by the companion drone indicates that there are no obstacles in the planned landing area of the parachute.

However, assisted landing in which landing of one or more of the drones may be assisted based on analysis of the images stream(s) captured by their companion drone is not limited to emergency landing and may be also applied to assist landing drone(s) which are in full control, i.e. not subject to any malfunction and/or emergency condition. For example, the image stream(s) captured by one or more of the drones may be analyzed to identify potential obstacles and/or hazards to the companion drone(s) during their landing whether in the air on course to the planned landing site as well as on ground at the landing site. Typically, each landing may be managed according to a landing protocol in which the companion drone escorts the landing drone using a predefined protocol that defines the position of the companion drone relative to the landing drone at every stage of the landing.

The assisted landing concept may be further extended to assist one or more delivery drones delivering one or more packages, for example, by lowering a cable while hovering above a delivery site based on analysis of the images stream(s) captured by their companion drones to ensure that the package lowered from the delivering drone and/or the cable extending from the delivering drone do not collide, hit and/or endanger one or more objects and/or obstacles located at and/or near the delivery site. Moreover, one or more deliveries may be managed according to a delivery protocol in which the companion drone escorts the delivery drone using a predefined protocol that defines the position of the companion drone relative to the delivery drone at every stage of the delivery.

In the highest automation level, one or more of the drones may be operated automatically based on the analysis of their respective image streams by one or more automated systems, services, applications and/or the like executing at the remote control system, at companion drone(s) and/or at remote control services. Typically, automatically operating the drones and adjusting their flight parameter(s) (e.g. position, route, speed, acceleration, altitude, etc.) in real-time (i.e. flight time) may be done in case of emergency, malfunction and/or any other unexpected scenarios.

For example, companion drones may be operated automatically to maintain VLOS with each other including dynamically adjusting one or more of the flight parameters of one or more of the companion drones, for example, position, speed, altitude and/or the like to overcome visibility limitations imposed by, for example, blocking object(s), poor visibility (e.g. low illumination, bad weather, etc.) and/or the like. Moreover, companion drones may be operated automatically to track each other around a center of field of View (FOV) of the imaging sensor(s) of the drone(s) to ensure that the tracked companion drones and their surrounding environment are effectively seen in the image streams.

In another example, companion drones may be operated automatically to support obstacle and collision avoidance by dynamically adjusting one or more of the flight parameters of one or more of the drones. Moreover, in case of emergency landing of a certain drone, the certain drone may be operated automatically to land in a landing site identified based on the analysis of the respective image stream captured by its companion drone including obstacle avoidance with detected ground object(s).

In another example, companion drones may be operated automatically to maintain GNSS (e.g. GPS) signal reception for one or more of the drones while one or more of their companion drones are flying in limited and potentially no GNSS signal zone such that the drones having GNSS signal coverage may supply a computed position to their no GNSS companion drone(s) computed based on the relative position of the companion drone(s) with respect to the GNSS capable drone(s).

In another example, companion drones may be operated automatically to support visual navigation for at least one of the drones such that one or more of the drones capable of visual navigation may supply the computed position to their companion drone(s) incapable of visual navigation.

In another example, the companion drone can perform during flight visual diagnostics of its peer drone, to verify that no physical damage or incorrect flight behavior exists in the peer drone. This can be done according to remote control system or flight operator initiated request or periodically according to a predefined scheme. Thus, for example the drone operator can verify the aerodynamic behavior of the peer drone in case he suspects that something is wrong with this drone.

Operating drones BVLOS based on analysis of image streams captured by companion drones flying in VLOS with each other may present major benefits and advantages compared to existing methods and system for controlling drones.

First, strict regulatory directives applicable in most countries require the drone operator to maintain a clear and unobstructed VLOS with the drone and at best allow for human observer(s) which are in VLOS with the drone and in communication with the operator. This may present a major range limitation for operating the drones, in particular in environments populated with potential obstacles, such as urban areas, indoor locations and/or the like. Moreover, in some cases the regulations prevent the drone operator from using any optical instruments which may limit the range of flight of the drone even in open spaces due to the limited eye sight of the drone operator. In order to comply with these regulations, the existing methods may be highly limited. In contrast, operating companion drones flying in clear VLOS with each other such that each drone and its vicinity are monitored by at least one other drone of the group enables easy and simple operation of the drones clearly visible in the captured image streams in full compliance with the regulations even when the drones are BVLOS of the operator and/or the remote control system.

Moreover, manually operating drones based on human sight requires high drone flight proficiency, experience and/or skill since multiple objects may need to be observed and tracked the 3D flight space of the drone. In contrast, operating the drones based on analysis of their respective image streams may significantly simplify the flight space since the drone may be depicted substantially in the center of the images with sufficient margins on each side to detect potential obstacles and/or objects which may present threat to the drone.

Furthermore, automatically operating the companion drones BVLOS may enable fast, real-time, accurate and reliable operation of the drones including rapid response to unexpected situations, in particular in case of emergency scenarios compared to manual operation as may be done by the existing methods.

In addition, applying the prediction based tracking for tracking the drones in the image streams may significantly reduce the computing resources, for example, processing resources, processing time, storage resources, communication bandwidth and/or the like compared to analyzing each image to detect and track the drones.

Also, providing the computed position to one or more of the companion drones which are incapable of computing their own position, for example, due to loss of GNSS signal or inability to detect salient landmarks may significantly enhance operability, reliability robustness of the drones flying in companion compared to the existing methods which may need to call back such a drone having no GNSS signal and may even need to emergency land it.

In addition, analyzing the image streams to monitor the route of one or more of the drones in order to detect deviation of the drone(s) from their planned route and moreover providing the deviating drone(s) correct path instructions may significantly increase robustness and immunity of the drones to hacking, spoofing and/or hijacking. For example, a hostile spoofing agent may hack one of the drones and may transmit false GPS signals to the hacked drone in attempt to divert it to a different route and hijack it and/or its cargo. However, while able to hack one or even a few of the drones, the hostile spoofing agent may be unable to simultaneously hack multiple drones, thus at least some of the drones are unharmed (un-hacked). Therefore, by constantly monitoring the route of the drones, a deviation of a hacked drone from its planned (predefined) route may be immediately detected and reported by its un-hacked and un-spoofed companion drone(s) and measures may be optionally applied to prevent the hijack, for example, correct route instructions may be transmitted to the hacked drone. Moreover, since the correct route instructions may be based on the position and/or location of the companion un-hacked drone(s) which may be operated in random flight patterns unknown to the hostile spoofing agent, the hostile spoofing agent may be unable to further spoof the hacked drone to follow a different route.

According to some embodiments of the present invention, groups of two or more drones may be selected automatically from a plurality of drones each assigned a respective one of a plurality of missions such that each group of drones may be operated in missions extending BVLOS of their operator(s) and/or remote control system(s).

The mission assigned to each of the drones, for example, an area monitoring mission, a sensory and/or imagery data capturing mission, a delivery mission and/or the like may be defined by a plurality of mission parameters, for example, a mission type (e.g. monitoring, sensory and/or imagery data capturing, delivery, etc.), a geographical area in which the mission is carried out, a destination, a route, a duration, a schedule (e.g. start time, end time, etc.) and/or the like.

The mission parameters of the plurality of missions assigned to the drones may be analyzed to identify drones which may be potentially grouped together to fly in companion with VLOS of each other. In particular, the mission parameters may be analyzed in conjunction with one or more operational parameters of each of the drones which may relate to the respective drone itself, for example, a speed, a flight range, an altitude, a power consumption, a battery capacity and/or the like and/or to the imaging sensor(s) of the respective drone 202, for example, a resolution, an FOV, a range, a zoom and/or the like.

One or more groups of drones may be selected to execute their assigned missions while flying in companion in VLOS with each other based on the mission parameters of the mission assigned to the drones coupled with the operational parameters of the drones.

Optionally, one or more of the groups of drones are selected and grouped to execute their assigned missions while flying in companion in VLOS with each other according to one or more optimization criteria, for example, a minimal mission duration, an earliest mission completion, a minimal mission power consumption, a minimal mission cost, a minimal drone utilization, a minimal turn-around time for the next mission and/or the like.

Selecting the groups of drones to be operated in companion in VLOS with each other may present major advantage since selection of drones to execute their missions in companion may be highly efficient thus reducing costs, drone utilization, mission time and/or the like while enabling BVLOS operation. Moreover, selecting the group(s) of companion drones according to the optimization criteria may additional flexibility and/or adjustability for each drone fleet and its user(s) and/or operator(s).

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer program code comprising computer readable program instructions embodied on a computer readable medium may be transmitted using any appropriate medium, including but not limited to wireless, wire line, optical fiber cable, RF, etc., or any suitable combination of the foregoing.

The computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

The computer readable program instructions for carrying out operations of the present invention may be written in any combination of one or more programming languages, such as, for example, assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages.

The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

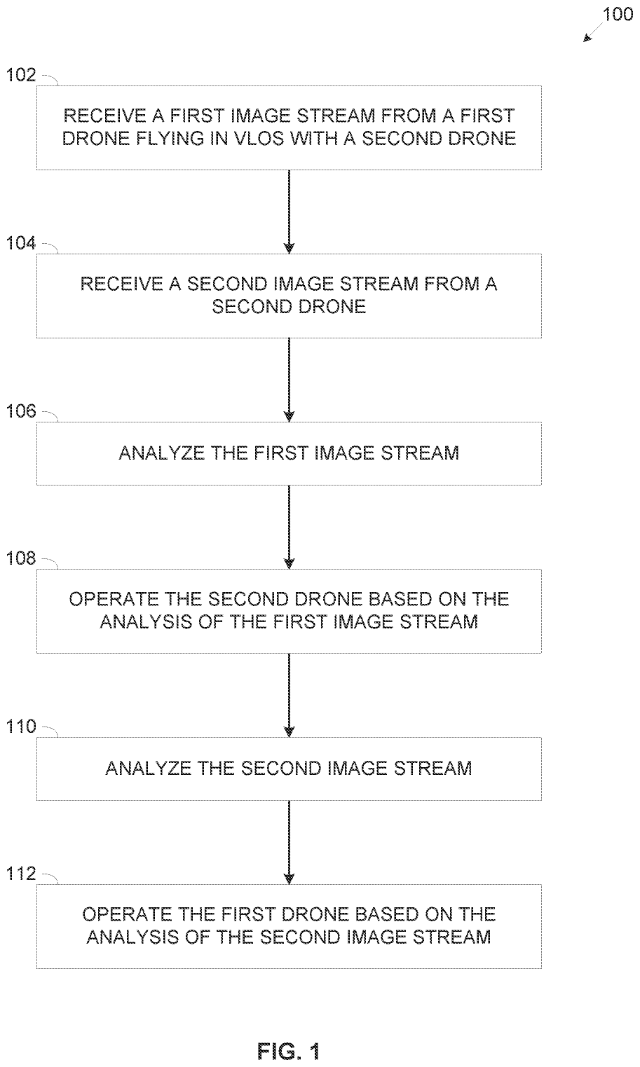

Referring now to the drawings, FIG. 1 is a flowchart of an exemplary process of operating each of a group of drones flying in companion in visual line of sight of each other according to an image stream captured by one or more of the companion drones, according to some embodiments of the present invention.

An exemplary process 100 may be executed to operate a group of two or more drones BVLOS, meaning that the drones may be remotely operated while outside visual sight of an operator. The group of drones, or at least pairs of drones of the group which may be outside the VLOS of the operator may fly in companion with each other such that each drone may fly in Visual Line of Sight (VLOS) of at least one of its companion drones.

In particular, each of the drones of the pair and/or the group may be operated based on analysis of one or more image streams captured by one or more of its companion drones which are equipped with one or more imaging sensors.

The process 100 is described herein after for operating drones which may include practically any UAV. This, however, should not be construed as limiting since the process 100 may be expanded and applied for operating BVLOS other autonomous vehicles which are not aerial vehicles, for example, ground vehicles and/or naval vehicles. For example, the process 100 may be applied for operating two or more ground autonomous vehicles which are BVLOS of their operator. In another example, the process 100 may be executed to operate two or more naval autonomous vehicles, for example, a boat, a hovercraft, a submarine and/or the like which are BVLOS of their operator. Moreover, the process 100 may be applied for operating a group comprising a mix of different autonomous vehicles, for example, one or more drones which are in VLOS with one or more ground and/or naval autonomous vehicles while BVLOS of their operator.

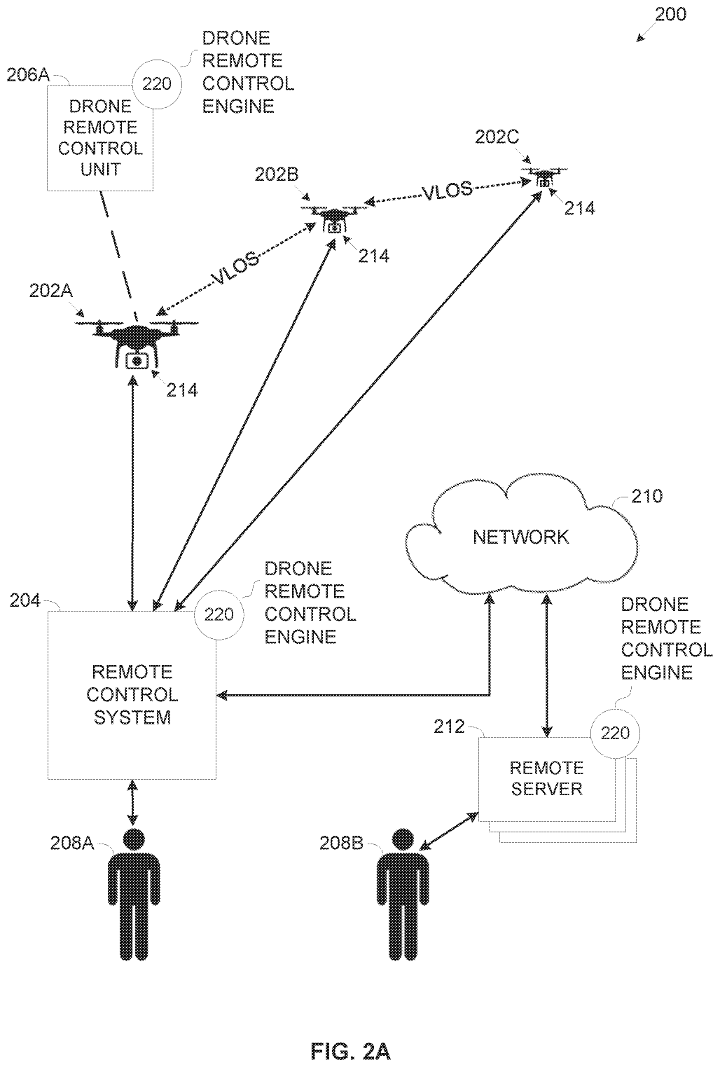

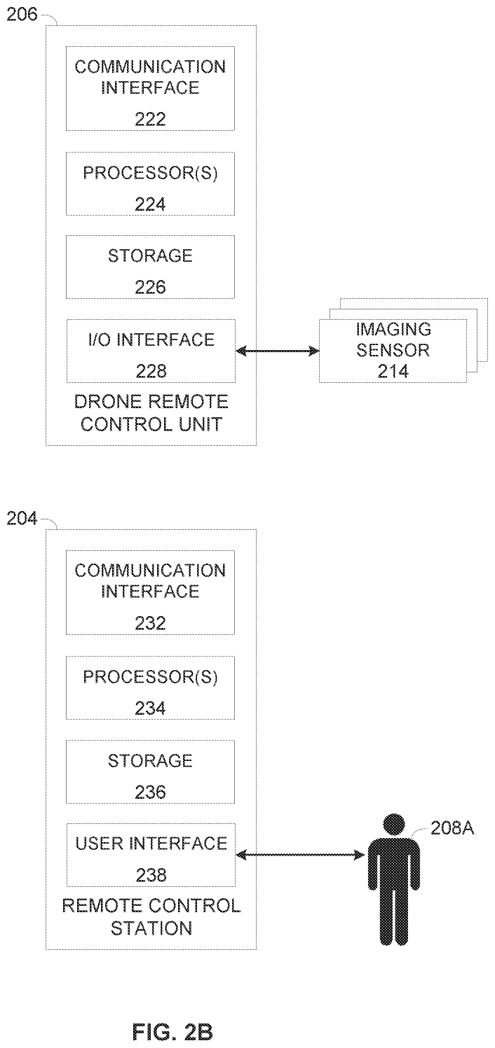

Reference is also made to FIG. 2A and FIG. 2B, which are schematic illustrations of an exemplary system for operating each of a group of drones flying in companion in visual line of sight of each other according to an image stream captured by one or more of the companion drones, according to some embodiments of the present invention.

As seen in FIG. 2A, a group of drones 202 comprising a plurality of drones 202, for example, a first drone 202A, a second drone 202B, a third drone 202C and so on may operate to execute one or more missions, for example, a monitoring mission, a sensory and/or imagery data capturing mission, a delivery mission, and/or the like in an exemplary environment 200, for example, an outdoor environment, an indoor environment and/or a combination thereof. The drones 202 may include practically any UAV, including UAM vehicles.

Each of the drones 202 may be equipped with one or more imaging sensors 214, for example, a camera, a video camera, a thermal imaging camera, an Infrared sensor, a depth camera, a Laser Detection and Ranging (LiDAR) sensor, a Radio Detection and Ranging (RADAR) sensor and/or the like. The imaging sensor(s) 214 may be deployed in the drones 202, for example, mounted, attached, integrated and/or otherwise coupled to the drone 202 to monitor and capture imagery data of the environment of the drone 202, for example, images, video feeds, thermal maps, range maps and/or the like.

Typically, each of the drones 202 may operate automatically according to a predefined mission plan defined by one or more mission parameters, for example, a destination, a route, a speed, an altitude, a timing (e.g. schedule, duration, etc.) and/or the like.

However, one or more of the drones 202 may be operated from one or more remote control systems 204, typically in case of an emergency, for example, potential collision with one or more objects detected in proximity to the drone 202, a malfunction to the drone 202, an emergency landing and/or the like. The remote control system 204, for example, a Ground Control Station (GCS), specifically a UAV GCS, an Unmanned Aircraft System Traffic Management (UTM), and/or the like may be ground based and/or airborne. Moreover, the remote control system 204 may be manually operated at least partially by one or more operators 208 and/or fully automated.

The drones 202 may therefore communicate with the remote control system 204 to transmit and/or receive data. For example, one or more of the drones 202 may transmit data to the remote control system 204, for example, identification (ID) data identifying the respective drone 202, position (location) data (e.g. longitude, latitude, altitude, etc.), speed, telemetry data and/or the like. In another example, the remote control system 204 may transmit data operation instructions to one or more of the drones 202.

The drones 202 may communicate with the remote control system 204 via one or more wireless communication channels, for example, a Radio Frequency (RF) link, a Wireless Local Area Network (WLAN, e.g. Wi-Fi) and/or the like. The drones 202 may directly communicate with the remote control system 204 via the wireless communication channel(s) and/or via an infrastructure network 210 comprising one or more wired and/or wireless networks, for example, a Local Area Network (LAN), a Wireless Local Area Network (WLAN), a Wide Area Network (WAN), a Municipal Area Network (MAN), a cellular network, the internet and/or the like.

Optionally, one or more of the drones 202 may communicate with one or more of the other drones 202 via one or more drone-to-drone communication channels, for example, an RF link, a WLAN and/or the like.

Moreover, optionally one or more of the drones 202 may serve as a relay for one or more of the other drones 202 for communicating with the remote control system 204. For example, assuming the drone 202B is out of range of its communication channel with the remote control system 204 and is therefore incapable of directly communicating with the remote control system 204. Further assuming that the drone 202B is in communication with the drone 202A via one or more of the drone-to-drone communication channels. In such case, the drone 202A which may be closer to the remote control system 204 and capable of directly communicating with the remote control system 204 may serve as a relay between the drone 202B and the remote control system 204.

The remote control system 204 may execute a drone remote control engine 220 for executing the process 100 to operate and/or support operating one or more of the drones 202. In some embodiments, the drone remote control engine 220 may be configured to automatically operate one or more of the drones 202. However, the drone remote control engine 220 may be configured to support one or more of the operators 208, for example, an operator 208A to manually operate one or more of the drones 202. The drone remote control engine 220 may further support combination of manual and automatic operation of one or more of the drones 202, for example, the drone remote control engine 220 may automatically operate one or more of the drones 202 while the operator(s) 208 may manually operate one or more other drones 202 using the drone remote control engine 220.

Optionally, the drone remote control engine 220 may be executed remotely by one or more remote servers 212, for example, a server, a computing node, a cluster of computing nodes, a cloud service (service, system, platform, etc.) and/or the like. The remote server(s) 212 may connect and communicate with the remote control system 204 via a network 210 comprising one or more. In such embodiments, the remote control system 204 may execute a local agent configured to communicate with both the drones 202, via the wireless communication channel(s), and with the remote server(s) 212, via the network 210, to support data exchange between the drones 202 and the remotely executed drone remote control engine 220.

As described for the drone remote control engine 220 locally executed by the remote control system 204, the drone remote control engine 220 executed remotely by the remote server 212 may be also configured to automatically operate one or more of the drones 202 and/or support one or more operators 208, for example, an operator 208B to manually operate one or more of the drones 202.

In another exemplary deployment, one or more remote users 208B using one or more client devices 212, for example, a server, a computer, a tablet, a Smartphone and/or the like may communicate with the drone remote control engine 220 executed by the remote control system 204 to manually operate one or more of the drones 202. For example, the remote user(s) 208B may execute one or more applications (e.g. web browser, mobile application, etc.) to connect to the drone remote control engine 220.

Optionally, one or more of the drones 202 may execute the drone remote control engine 220 to operate one or more of the other drones 202. For example, the drone 202A may execute an instance of the drone remote control engine 220 to operate the drone 202B, specifically in case the drone 202B experiences an emergency situation. In another example, a UAM vehicle 202 may execute an instance of the drone remote control engine 220 to operate one or more other drones 202.

As seen in FIG. 2B, one or more of the drones 202 may include a drone remote control unit 206 comprising a communication interface 222 for communicating with the remote control system 204, a processor(s) 224 for executing the process 100 and/or part thereof, and a storage 226 for storing data and/or program (program store).

The drone remote control unit 206 may further include an Input/Output (I/O) interface 222, comprising one or more interfaces and/or ports for connecting to one or more imaging sensors 214 of the drone 202, for example, a network port, a Universal Serial Bus (USB) port, a serial port, a Controller Area Network (CAN) bus interface and/or the like.

The communication interface 222 may include one or more wireless communication interfaces for communicating with the remote control system 204, directly and/or via the network 210. Via its communication interface 222, one or more of the drones 202 may further communicate with one or more of the other drones 202.

The processor(s) 224, homogenous or heterogeneous, may include one or more processors arranged for parallel processing, as clusters and/or as one or more multi core processor(s). The storage 226 may include one or more non-transitory persistent storage devices, for example, a Read Only Memory (ROM), a Flash array, a hard drive and/or the like. The storage 226 may also include one or more volatile devices, for example, a Random Access Memory (RAM) component, a cache memory and/or the like.

The processor(s) 224 may execute one or more software modules such as, for example, a process, a script, an application, an agent, a utility, a tool, an Operating System (OS) and/or the like each comprising a plurality of program instructions stored in a non-transitory medium (program store) such as the storage 226 and executed by one or more processors such as the processor(s) 224. The processor(s) 224 may optionally integrate, utilize and/or facilitate one or more hardware elements (modules) integrated, utilized and/or otherwise available in the drone 202, for example, a circuit, a component, an Integrated Circuit (IC), an Application Specific Integrated Circuit (ASIC), a Field Programmable Gate Array (FPGA), a Digital Signals Processor (DSP), a Graphical Processing Unit (GPU), an Artificial Intelligence (AI) accelerator and/or the like.

The processor(s) 224 may therefore execute one or more functional modules implemented using one or more software modules, one or more of the hardware modules and/or combination thereof, for example, the drone remote control engine 220 configured to execute the process 100 and/or part thereof.

While it is possible that the drone remote control unit 206 is facilitated by a dedicated unit such as the drone remote control unit 206, typically the drone remote control unit 206 may be integrated with one or more other control and/or processing units of the drone 202, for example, a control unit controlling operation of the drone 202 and/or the like which may execute the drone remote control engine 220.

The remote control system 204 may include a communication interface 232 such as the communication interface 222 for communicating with one or more of the drones 202 and optionally with one or more of the remote serves 212, a processor(s) 234 such as the processor(s) 224 for executing the process 100 and/or part thereof, and a storage 236 such as the storage 226 for storing data and/or program (program store).

The remote control system 204 may typically further include a user interface 238 comprising one or more Human Machine Interfaces (HMI) for interacting with the operator(s) 208A, in particular to enable the operator(s) 208A to interact with the drone remote control engine 220 to operate one or more of the drones 202. The user interface 238 may include, for example, a screen, a touch screen, a keyboard, a keypad, a pointing device (e.g., mouse, trackball, etc.), a speaker, a microphone and/or the like.

The processor(s) 234, homogenous or heterogeneous, may include one or more processors arranged for parallel processing, as clusters and/or as one or more multi core processor(s). The storage 236 may include one or more non-transitory persistent storage devices as well as one or more volatile devices.

The processor(s) 234 may execute one or more software modules. The processor(s) 234 may optionally integrate, utilize and/or facilitate one or more hardware elements (modules) integrated, utilized and/or otherwise available in the remote control system 204, for example, a circuit, a component, an IC, an ASIC, an FPGA, a DSP, a GPU, an AI accelerator and/or the like.

The processor(s) 234 may therefore execute one or more functional modules implemented using one or more software modules, one or more of the hardware modules and/or combination thereof, for example, the drone remote control engine 220 configured to execute the process 100 and/or part thereof.

As seen in FIG. 2A, one or more and optionally all of the drones 202 may fly out of VLOS of the remote control system 204. However, while one or more of the drones 202 may fly BVLOS of the remote control system 204, each of the drones 202 may be in VLOS of at least one of the other drones 202, i.e., each drone 202 may have at least one companion drone 202 which is in VLOS with the respective drone 202.

Drones 202 which are in VLOS of each other and grouped as companion drones 202 may therefore monitor their companion drones 202 using their imaging sensor(s) 214 to capture image streams depicting their companion drones 202. Since the companion drone 202 of a respective drone 202 may be located practically in practically any direction (angle, distance altitude, etc.) with respect to the respective drone 202, the imaging sensor(s) 214 of the respective drone 202 and/or optionally the position of the receptive drone 202 itself may be configured, operated and/or adjusted to put the companion drone 202 in a Field of View (FOV) of the imaging sensor(s) 214, typically substantially in a center of the FOV.

For example, one or more of the drones 202 may include one or more gimbal mounted imaging sensors 214 which may be dynamically positioned and adjusted to face their companion drone 202 such that the companion drone 202 is in the FOV of the imaging sensor(s) 214. In another example, one or more of the drones 202 may include one or more wide FOV imaging sensors 214 configured to monitor and capture imagery data (images stream) of a wide portion of the environment of the respective drone 202 including their companion drone 202. In another example, one or more of the drones 202 may be operated and/or instructed to fly in a position to bring and/or put their companion drone 202 in the FOV of their imaging sensor(s) 214.

Optionally, one or more of the imaging sensor(s) 214 of one or more of the drones 202 may be mounted on one or more arms extending from the respective drone 202. As such, while the extending arm mounted imaging sensor(s) 202 of a respective drone 202 captures one or more image streams of one or more companion drones 202, the image stream(s) may further depict the respective drone 202 and/or part thereof as well as a at least part of the surrounding environment of the respective drone 202.

Additionally, and/or alternatively, the drones 202 may be operated to fly in one or more predefined air-corridors, or more generally, in one or more monitored flight areas such as, for example, a plant, a stadium, a field and/or the like which are monitored by one or more statically deployed imaging sensors such as the imaging sensors 214. This means that rather than being airborne, the stationary (ground) imaging sensors, for example, pole-mounted imaging sensors may be deployed on the ground, on one or more buildings, on one or more towers and/or the like, collectively designated ground. The stationary imaging sensors may provide at least partial overlapping coverage of the monitored flight area such that the entire monitored flight area is subject to visual monitoring and inspection. In such cases, the companion drone 202 may be replaced by the stationary imaging sensors and thus no multi-drone formation may be required while flying in the monitored flight area. Tracking each drone 202 flying in the monitored flight area is transferred by hand-shaking from one static imaging sensor to the next within the monitored flight area. All other functionalities of operating the drones 202 are unchanged.

A plurality of flight formations may be applied for the drones 202 to ensure that each of the drones 202 flies in companion with at least one of the other drones 202 having VLOS to the respective drone 202, i.e. a companion drone 202. The flight formations may be set and/or defined according to one or more mission parameters of the drones 202, according to one or more operational parameters of the drones 202, one or more terrain attributes, one or more environmental conditions, and/or the like as well as a combination thereof.

For example, one or more flight formations may be selected according to one or more of the mission parameters of one or more of the drones 202, for example, a route, an altitude and/or the like. In another example, one or more flight formations may be selected according to one or more of the operational parameters of one or more of the drones 202, for example, a capability of its imaging sensor(s) 214 such as, for example, a rotation angle, an FOV, zoom, resolution, technology (e.g. visible light sensor, LiDAR, RADAR, spectral range, etc.) and/or the like. In another example, one or more flight formations may be selected according to one or more of the terrain attributes of the flight zone (area) of the drones 202, for example, presence of potentially blocking objects (e.g. structures, vegetation, natural objects, etc.), regulatory restrictions relating to the flight zone (e.g. forbidden flight above people, etc.) and/or the like. In another example, one or more flight formations may be selected according to one or more of the environmental conditions identified and/or predicted for the flight zone of the drones 202, for example, a sun angle which may degrade visibility of the companion drones 202, visibility conditions (e.g. smog, fog, rain, snow, clouds, etc.) and/or the like.

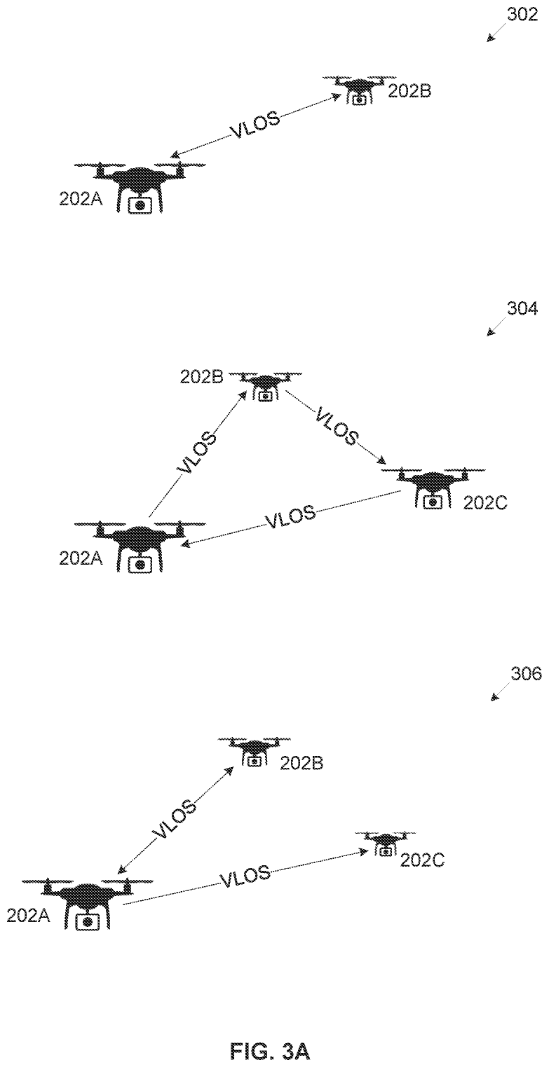

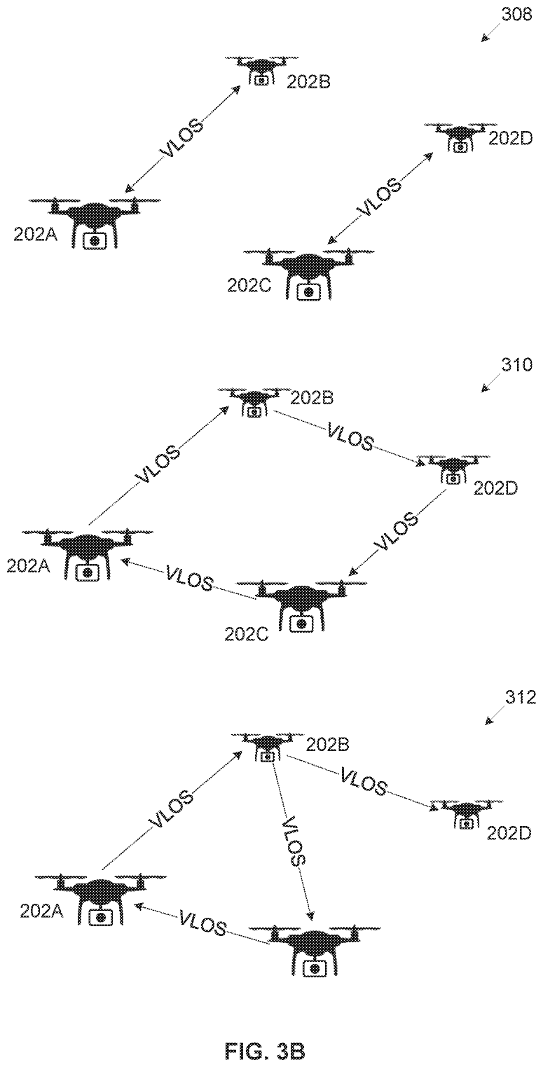

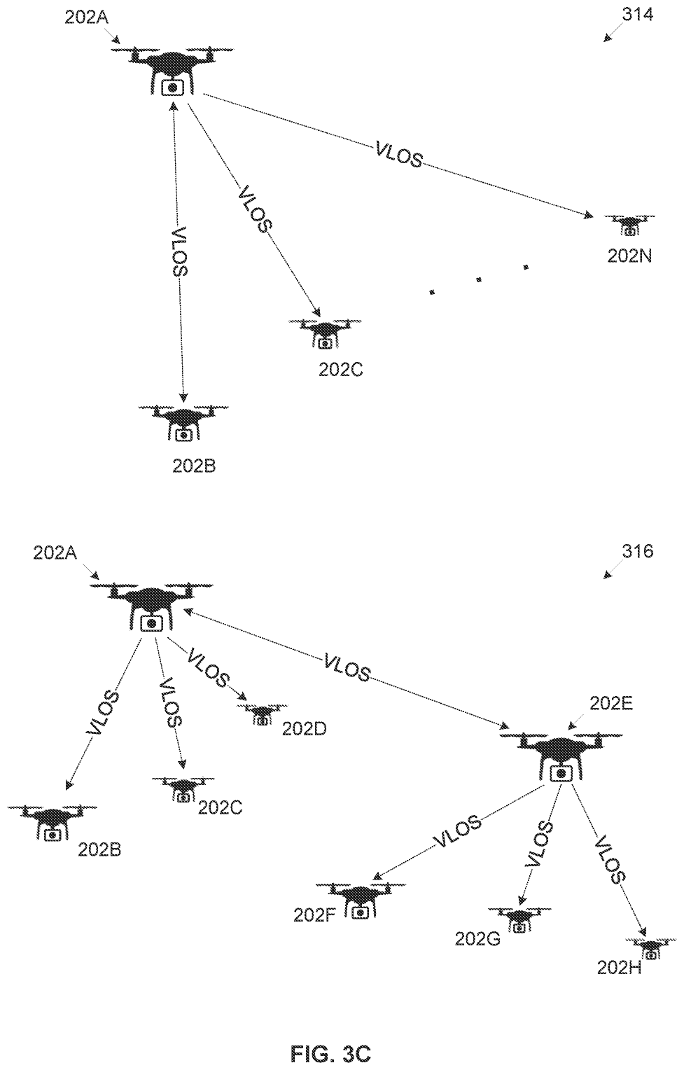

Reference is now made to FIG. 3A FIG. 3B and FIG. 3C, which are schematic illustrations of exemplary drone flight formations employed to maintain VLOS between companion drones in order to operate the drones based on image streams captured by their companion drones, according to some embodiments of the present invention.

A plurality of exemplary flight formations 302, 304, 306, 308, 310, 312, 314 and 316 present drones such as the drones 202 which are operated to maintain VLOS with one or more other drones 202 thus ensuring each drone 202 is monitored by at least one companion drone 202, specifically ensuring that each drone 202 may be depicted in an image stream captured by one or more imaging sensors such as the imaging sensor 214 of its companion drone(s) 202.

It should be noted that the VLOS arrows marked between the drones 202 in the exemplary flight formations designate a companionship relation between the drones 202. Obviously if a certain drone 202 is in VLOS of another drone 202, the other drone 202 may also be in VLOS of the certain drone 202. However, while both these drones 202 may be in VLOS with each other, one drone 202 may not necessarily be the companion of the other drone 202 as is demonstrated herein after. The arrow therefore designates the companionship relation rather than the actual VLOS attribute.

The exemplary flight formation 302 demonstrates the most basic and minimal formation comprising a pair (tandem) formation in which two drones 202, for example, a first drone 202A and a second drone 202B are grouped together and operated to fly in VLOS with each other such that the drone 202A is the companion of the drone 202B and vice versa, the drone 202B is the companion of the drone 202A.

The exemplary flight formation 304 is a circular formation in which three drones 202, for example, a first drone 202A, a second drone 202B and a third drone 202C are grouped together and each drone 202 is operated to fly in VLOS with an adjacent (neighbor) companion drone 202. For example, the drone 202A may be in VLOS with its companion drone 202B which in turn may be in VLOS with its companion drone 202C which in turn may be in VLOS with its companion drone 202A.

The exemplary flight formation 306 is a dual-companion formation in which three drones 202, for example, a first drone 202A, a second drone 202B and a third drone 202C are grouped together and one of the drones 202, for example, the drone 202A is operated to fly in VLOS with the other two companion drones 202B and 202C. Such flight formation(s) may be applied in case the drone 202A is capable to simultaneously monitor its two companion drones 202b and 202C. For example, the drone 202A may include multiple imaging sensor(s) 214 which may be operated to simultaneously monitor its two companion drones 202B and 202C. In another example, the drone 202A may be operated to a position from which it may simultaneously monitor its two companion drones 202B and 202C.

The flight formations may include combinations and/or variations of the exemplary formations described herein before.

For example, assuming four drones 202, a first drone 202A, a second drone 202B, a third drone 202C and a fourth drone 202d are operated to execute assigned missions in a certain area. In such case, one or more flight formations may be applied to ensure that each of the drones 202 is a companion drone of at least one of the other drones 202 which is in VLOS with the respective drone 202 and monitors the companion drone. For example, the four drones 202A, 202B, 202C and 202D may be grouped into two pairs as seen in formation 308 where in each of the pairs, each drone 202 of the pair is the companion of the other drone 202 of the pair. For example, the drones 202A and 202B may be grouped together in a first pair such that the drone 202A is in VLOS of its companion drone 202B and monitors it and vice versa, the drone 202B monitors its companion drone 202A. The drones 202C and 202D may be grouped together in a second pair such that the drone 202C is in VLOS of its companion drone 202D and monitors it and vice versa, the drone 202D monitors its companion drone 202C. In another example, as seen in formation 310, the four drones 202A, 202B, 202C and 202D may be grouped together in a circular formation in which the drone 202A monitors its companion drone 202B which in turn monitors its companion drone 202D which in turn may monitor its companion drone 202C which in turn may monitor its companion drone 202A. In another example, a combined flight formation 312 combining the circular and dual-companion formations may group together the four drones 202A, 202B, 202C and 202D such that the drone 202A monitors its companion drone 202B which in turn monitors two companion drones 202D and 202C which in turn may monitor its companion drone 202A.

The exemplary flight formation 314 is a multi-companion formation (interchangeably designated platoon formation) in which a plurality of N drones 202 (N>2), for example, a first drone 202A, a second drone 202B, a third drone 202C and so on to a N^{th} drone 202N are grouped together in a supervisor-subordinate formation in which a supervisor drone 202 may monitor a plurality of subordinate drones 202. Moreover, the supervisor drone may be a companion of one or more of the subordinate drones 202 which may monitor the supervisor drone 202. For example, the drone 202A may be operated as the supervisor to monitor a plurality of subordinate drones 202, for example, the drone 202B, the drone 202C and so on to the drone 202N. The supervisor drone 202A in turn may be monitored by one or more of the subordinate drones 202, for example, the drone 202B.

The exemplary flight formation 316 is combined formation combining the platoon and pair formations. As seen drones 202A, 202B, 202C and 202D may be grouped in a first group and operated in a multi-companion formation where the drone 202A is operated as a supervisor drone 202 monitoring its three subordinate companion drones 202B, 202C and 202D. Drones 202E, 202F. 202G and 202H may be grouped in a second group also operated in a multi-companion formation where the drone 202E is operated as a supervisor drone 202 monitoring its three subordinate companion drones 202F, 202G and 202H. However, rather than operating one or more of the subordinate drones 202 to monitor their supervisor drone 202, the two supervisor drones 202a and 202E are operated in pair formation where the two drones 202A and 202E are companion drones 202 monitoring each other.

As stated herein before, the flight formations 302, 304, 306, 308, 310, 312, 314 and 316 are only exemplary formations and should not be construed as limiting since other formations may be applied as may be apparent to a person skilled in the art.

Reference is made once again to FIG. 1.

For brevity the process 100 is described for two drones 202, specifically a first drone 202A and second drone 202B flying in companion in VLOS with each other and are each operated to monitor its companion drone 202 and capture an image stream depicting its companion drone 202. The captured image streams depicting the companion drones 202 may be then used to operate the companion drones accordingly. This however, should not be construed as limiting, since the process 100 may be expanded and scaled to a plurality of drones 202 flying in VLOS of each other in one or more of a plurality of flight formations of which some are described herein before. These drones 202 may monitor companion drones 202 and capture image streams depicting the companion drones 202 which may be operated based on the captured image streams. This means that, one or more other drones 202 other than the first drone 202A and the second drone 202B may be operated according to one or more image streams depicting the receptive other drone 202 which may be captured by the imaging sensor(s) 214 of the first drone 202A, of the second drone 202B and/or of one or more of the other drones 202.

Moreover, as previously described, the process 100 and/or part thereof may be executed by one or more instances of the drone remote control engine 220 which may be executed by one or more executing entities, for example, the remote control system 204, by the remote server 212 and/or by one or more of the drones 202, i.e., by the first drone 202 and/or by the second drone 202.

The process 100 is described herein after in general regardless of where the drone remote control engine 220 is executed while addressing different and/or specific features which may apply to the execution of the drone remote control engine 220 by one or more of the executing entities. For example, in case executed by the remote control system 204 and/or by the remote server 212 (via the remote control system 204), the drone remote control engine 220 may operate automatically and/or support manual operation of the first and/or second drones 202. However, in case, the drone remote control engine 220 is executed by one of the drones 202, the drone remote control engine 220 may be applied to operate automatically and/or support manual operation of only the companion drone 202.

As shown at 102, the process 100 starts with the drone remote control engine 220 receiving a first image stream captured by one or more imaging sensors 214 mounted and/or otherwise coupled to a first drone 202A which flies in VLOS with a second drone 202B. In particular, the first image stream comprising a plurality of consecutive images (e.g. images, thermal maps, ranging maps, etc.) may depict the second drone 202B, designated companion drone of the first drone 202A, and at least some of the vicinity of the second drone 202B, i.e., the environment surrounding the second drone 202B.

The first drone 202A and the second drone 202B may fly in companion in one or more environments, for example, an outdoor environment under open sky, an indoor environment, for example, a closed area, a roofed area and/or the like such as, for example, a hangar, a warehouse and/or the like and/or a combination thereof, for example, a partially roofed stadium, a partially roofed market and/or the like.

The first image stream may be received by the drone remote control engine 220 depending on its deployment. For example, in case the drone remote control engine 220 is executed by the remote control system 204, the remote control system 204 may receive the first image stream from the first drone 202A via one or more of the communication channels established between the remote control system 204 and the first drone 202A. In another example, in case the drone remote control engine 220 is executed by one or more of the remote servers 212, the remote server(s) 212 may receive the first image stream via the remote control system 204 via the network 210.

In case the drone remote control engine 220 is executed by the first drone 202A, the remote control engine 220 may directly connect to the imaging sensor(s) 214 of the first drone 202A to receive the first image stream. In case the drone remote control engine 220 is executed by the second drone 202B, the remote control engine 220 may receive the first image stream from the first drone 202A via one or more of the drone-to-drone communication channels established between the first drone 202A and the second drone 202B and/or via the remote control system 204 which may be in communication with both the first drone 202A and the second drone 202B.

As shown at 104, the drone remote control engine 220 may receive a second image stream captured by one or more imaging sensors 214 mounted and/or otherwise coupled to the second drone 202B. In particular, the second image stream comprising a plurality of consecutive images may depict the first drone 202A, designated companion drone of the first drone 202A, and at least some of the vicinity of the first drone 202A, i.e., the environment surrounding the first drone 202A.

As described in step 102 for the first image stream, the second image stream may be received by the drone remote control engine 220 depending on the deployment of the drone remote control engine 220.

As shown at 106, the drone remote control engine 220 may analyze one or more images extracted from the first image stream depicting the second drone 202B.

As shown at 108, the second drone 202B may be operated based on analysis of the first image stream captured by the imaging sensor(s) 214 of the first drone 202A which depict the second drone 202B and its vicinity.

Complementary, as shown at 110, the drone remote control engine 220 may analyze one or more images of the second image stream depicting the first drone 202A and as shown at 112, the first drone 202A may be operated based on analysis of one or more images extracted from the second image stream captured by the imaging sensor(s) 214 of the second drone 202B which depict the first drone 202A and its vicinity.

The first drone 202A and/or the second drone 202B may typically fly autonomously according to a predefined mission plan dictating one or more mission parameters of the mission assigned to the first drone 202A and/or the second drone 202B respectively, for example, a route, a path, a speed, an altitude and/or the like.

Actively operating the first drone 202A and/or the second drone 202B, either manually and/or automatically, may therefore take place in case of one or more emergency situations and/or potential emergency situations. Such potential emergency situations may include, for example, collision and/or obstacle avoidance to prevent the first drone 202A and/or to the second drone 202B from colliding with one or more objects and/or obstacles detected in their proximity in the respective image stream. In another example, the potential emergency situations may include a malfunction of the first drone 202A and/or to the second drone 202B which may require special care, for example, emergency landing the respective drone 202, distancing the respective drone 202 from sensitive areas (e.g. human population, inflammable substances, etc.) and/or the like. In another example, the potential emergency situations may include a deviation of the first drone 202A and/or to the second drone 202B from their planned route and/or position which may require special care, for example, manually operating the respective drone 202 to a certain location, a certain position, a certain altitude and/or the like.

As stated herein before, the drone remote control engine 220 may be configured for several automation levels in analyzing the first and/or or second image streams and operating and/or supporting operation of the first and/or second drones 202A and 202B. The nature, level and/or extent of the analysis and drone control applied by the drone remote control engine 220 may therefore vary depending on the defined, set and/or selected automation level.

In its basic automation level, the drone remote control engine 220 may be configured to support one or more operators 208 to manually operate of the first drone 202A and/or the second drone 202B. In such case, the drone remote control engine 220 may be configured to present the first image stream and/or the second image stream to the operator(s) 208. The drone remote control engine 220 may present the first and/or second image streams via one or more displays (screens) of the remote control system 204 and/or of the remote server(s) 212 depending on the deployment of the drone remote control engine 220 and/or on the location of the operator(s) 208. For example, in case the first and/or second drones 202A and 202B are manually operated by the operator(s) 208A, the drone remote control engine 220 may be configured to present the first and/or second image streams via the user interface 238. In another example, in case the first and/or second drones 202A and 202B are manually operated by the operator(s) 208B, the drone remote control engine 220 may be configured to present and/or control presentation of the first and/or second image streams via a user interface of the remote server(s) 212.

The drone remote control engine 220 may be further configured to receive control instructions from the operator(s) 208 for operating the first drone 202A and/or the second drone 202B. For example, the drone remote control engine 220 may receive the control instructions via one or more user input interfaces, for example, a joystick, a mouse, a microphone, a keyboard and/or the like of the remote control system 204 and/or of the remote server 212 depending on the on the deployment of the drone remote control engine 220 and/or on the location of the operator(s) 208. The transmit the control instructions received from the operator(s) 208 to the first and/or second drone 202A via one or more of the communication channels established between the remote control system 204 and the drones 202A and/or 202B respectively.

In a more advanced automation level, the drone remote control engine 220 may be further configured to analyze the first and/or second image streams depicting the second drone 202B and the first drone 202A respectively and optionally at least some of their surrounding environment. To this end the drone remote control engine 220 may apply one or more image analysis methods, tools, algorithms and/or models as known in the art, for example, computer vision, image processing, classifiers, machine learning models (e.g. neural networks, Support Vector Machines (SVM), etc.) and/or the like.

The first image stream and the second image stream captured by the first drone 202A and the second drone 202B respectively may be similarly analyzed by the drone remote control engine 220. For brevity, the text may therefore address only the first image stream which may be analyzed and used to operate the second drone 202B. However, the drone remote control engine 220 may apply the same analysis to the second image stream to operate and/or support operation of the first drone 202A.

For example, the drone remote control engine 220 may analyze the first image stream depicting the second drone 202B and optionally at least some of the surrounding environment of the drone 202B to detect the second drone 202B in one or more of the images extracted from the first image stream. In particular, the drone remote control engine 220 may detect the location of the second drone 202B in at least some of the images of the first image stream which may be translated as known in the art to a real-world position (location) of second drone 202B, for example, longitude, latitude, altitude and/or the like.

The drone remote control engine 220 may further track the drone 202B in a plurality of consecutive images of the first image stream to identify and determine its position over time. However, while the drone remote control engine 220 may analyze each image extracted from the first image stream to detect the second drone 202B and track it accordingly, the drone remote control engine 220 may optionally track the second drone 202B by applying one or more prediction algorithms configured to predict the position of the second drone 202B based on detection of the second drone 202B in previous images of the first image stream. Using the prediction algorithm(s), the drone remote control engine 220 may continuously track the second drone 202B while analyzing only a subset of the images of the first image stream, for example, images periodically selected from the first image stream, for example, every other image, every fourth image, every tenth image and/or the like.

The prediction algorithms used by the drone remote control engine 220 may include, for example, a Kalman filter algorithm which may predict a position of the drone 202B based on its detected position in one or more images extracted from the first image stream optionally coupled with possible and/or probable prediction uncertainties. The Kalman filter algorithm may further update and adjust its prediction of the position of the second drone 202B based on comparison between the predicted position of the second drone 202B and its actual position as detected in one or more succeeding images extracted from the first image stream.

In another example, the drone remote control engine 220 may detect and track the second drone 202B using one or more trained machine learning (ML) models trained to predict the position of the second drone 202B based on one or more flight patterns identified for the second drone 202 based on the analysis of the first image stream. The flight pattern(s) may include and/or indicate one or more flight parameters of the second drone 202B, for example, speed, acceleration, altitude, maneuvers and/or the like.

The ML model(s) may be trained using training samples depicting one or more drones 202 flying in one or more indoor and/or outdoor environments on a plurality of missions. Moreover, the ML model(s) may be specifically trained for predicting the flight pattern(s) of the specific second drone 202B using training samples depicting one or more drones of the same type as the drone 202B (e.g. size, operational parameters, etc.), drones 202 operated in the same environments and areas as mission and/or area of flight of the second drone 202B and/or the like.

The trained ML model(s) may be then applied to at least some of the images of the first image stream to identify the flight pattern(s) of the second drone 202B and further predict a future position of the second drone 202B based on its identified flight pattern(s).

The drone remote control engine 220 may further analyze at least some of the surrounding environment of the second drone 202B seen in the first image stream and/or part thereof to identify one or more objects, obstacles, elements, environmental conditions, events, potential malfunctions of the second drone 202B, potential emergency situations and/or the like. The drone remote control engine 220 may further analyze the first image stream to identify one or more attributes of one or more of the detected objects and/or potential obstacles, for example, a type, a location, a velocity, a heading (movement vector) and/or the like.

The drone remote control engine 220 may apply one or more visual analysis methods, algorithms and/or tools as known in the art to detect objects in the first image stream, for example, image processing, computer vision and/or the like.

For example, based on the analysis of one or more images of the first image stream, the drone remote control engine 220 may identify one or more objects and/or potential obstacles in the environment of the second drone 202B. The detected objects may include, for example, aerial vehicle (e.g. another drone 202, plane, etc.), a bird, a structure, an infrastructure object (e.g. power line pole, communication tower, traffic pole, flagpole, etc.), a ground vehicle (e.g. car, truck, train, etc.), a naval vehicle (e.g. boat, ship, etc.), a person, a pet, a vegetation element (e.g. tree, etc.) and/or the like. The drone remote control engine 220 may further identify and/or determine, based on the analysis of the first image stream, whether one or more of the detected objects and/or obstacles may present a threat of collision with the second drone 202B, i.e. whether the detected object(s) and/or obstacle(s) may be in a collisions course with the second drone 202B and may potentially collide with the second drone 202B.

In another example, based on the analysis of the first image stream and/or part thereof, the drone remote control engine 220 may identify one or more malfunctions, emergency situations and/or the like of the second drone 202B. For example, the drone remote control engine 220 may identify damage to one or more exterior parts of the second drone 202B, smoke coming out of the second drone 202B and/or the like which may be indicative of a malfunction experienced by the second drone 202B. In another example, the drone remote control engine 220 may identify that the second drone 202B is moving in an unexpected and/or unplanned pattern, for example, swirling around itself, diving down and/or the like which may be indicative of a malfunction experienced by the second drone 202B.

In another example, based on the analysis of one or more images of the first image stream, the drone remote control engine 220 may identify one or more visibility and/or environmental conditions, for example, illumination level (due to day, night, dusk, clouds, etc.), fog, smog, precipitation (e.g. rain, hail, snow, etc.) and/or the like.

Optionally, since the position of the second drone 202B (absolute position and relative to its companion drone) is known, the analysis of the image stream(s) captured by the companion first drone 202A may be used to update one or more maps, specifically 3D maps of the flight route (path) of the second drone 202B and at least part of its surrounding area. In particular, the maps may be updated in real-time to document one or more objects and/or obstacles identified in the image stream(s) optionally coupled with one or more of their attributes, for example, location, velocity, heading and/or the like thus generating a live update of the map employed to design and control the flight route of one or more of the drones 202A and 202B.

The drone remote control engine 220 may optionally generate one or more alerts relating to operation of the drones 202A and/or 202B and/or to one or more events relating to the drones 202A and/or 202B. The drone remote control engine 220 may transmit the alerts to alert one or more of the operators 208, to the remote control system 204 and/or to one or more automated systems, services and/or the like. The drone remote control engine 220 may further transmit, forward and/or report one or more of the alerts to the UTM system which may be a higher level system deployed to control, supervise and/or monitor one or more remote control systems 204 and optionally coordinate multiple remote control systems 204.

For example, the drone remote control engine 220 may generate alerts in real-time in response to detection of one or more of the objects, obstacles, elements, environmental conditions, events, potential malfunctions, potential emergency situations and/or the like.

For example, the drone remote control engine 220 detects one or more objects (e.g. another drone, a plane, a bird, a structure, etc.) in the environment of the drone 202B, the drone remote control engine 220 may generate one or more alerts. Moreover, the drone remote control engine 220 may be configured to support collision avoidance and generate one or more alerts in case one or more obstacles and/or objects are detected in close proximity to the second drone 202B and moreover in case they are in collision path with the second drone 202B.

In another example, assuming the drone remote control engine 220 identifies a potential malfunction of the second drone 202B, the drone remote control engine 220 may generate one or more alerts.

The drone remote control engine 220 may apply one or more methods, techniques and/or modalities to output the alerts. For example, in case an alert is directed to alert an operator 208, the drone remote control engine 220 may instruct presenting a visual alert message on a display used by the operator 208, for example, a display of the remote control system 204, a display of the remote server 212 and/or the like. In another example, the drone remote control engine 220 may instruct generating an audible alert sound and/or message to the operator(s) 208 via one or more speakers of the remote control system 204 and/or of the remote server 212. However, in case the alert is directed to inform one or more other systems, services and/or the like relating to the operation of the drone 202B, the drone remote control engine 220 may use one or more Application Programming Interfaces (API), system calls and/or communication protocols to communicate with the other systems and/or services.

The drone remote control engine 220 may optionally analyze the first image stream, specifically over time, to monitor the route (i.e., path, course, etc.) of the second drone 202B. The drone remote control engine 220 may further compare between the actual route of the second drone 202B as detected in the analysis and a predefined route set for the second drone 202B. The drone remote control engine 220 may issue one or more alerts, either to the operator(s) 208 and/or to the other system(s) and/or service(s) relating to the operation of the drone 202B, in case of deviation of the second drone 202B from its predefined route.

Moreover, in case the drone remote control engine 220 detects such a deviation in the route of the second drone 202B from its predefined route, the drone remote control engine 220 may transmit correct route instructions to the second drone 202B. The second drone 202B may use and/or apply the correct route instructions received from the first drone 202A to continue its flight, for example, resume its predefined route. For example, assuming the drone remote control engine 220 is executed by the first drone 202A and the route of the second drone 202B is stored at the first drone 202A and/or obtained by the first drone 202A from a remote resource, for example, the remote control system 204. In such case, the first drone 202A may transmit correct route instructions to its companion second drone 202B via the drone-to-drone communication channel(s) established between the first drone 202A and the second drone 202B. In one example, the first drone 202A may extract one or more waypoints from the predefined route of the second drone 202B locally stored at the first drone 202A. The first drone may then transmit navigation instructions to the second drone 202B which may adjust its flight route accordingly. In another example, the first drone 202A may transmit dead reckoning navigation based instructions to the second drone 202B based on the position and/or location of the first drone 202A such that the second drone may apply dead reckoning navigation according to the received dead reckoning navigation instructions.

Optionally, the drone remote control engine 220 may further compute, detect and/or otherwise determine one or more of the flight parameters of the second drone 202B, for example, speed, altitude, flight direction, orientation (for example, with respect to ground) and/or the like. To this end, the drone remote control engine 220 may apply one or more methods, techniques and/or algorithms as known in the art. For example, as the operational parameters of the imaging sensor(s) 214 capturing the first image stream, for example, resolution, pixel size, frame rate and/or the like may be known, the drone remote control engine 220 may compute the speed of the second drone 202B based on its displacement in consecutive images of the first image stream, i.e., a change in the location of the second drone 202B in the consecutive images. In another example, based on the operational a parameters of the imaging sensor(s) 214, the drone remote control engine 220 may compute the altitude of the drone 202B based on comparison to one or more detected objects, for example, a car, a building and/or the like which dimensions are known.

Moreover, the drone remote control engine 220 may compute, detect and/or otherwise determine one or more of the flight parameters of the second drone 202B based on sensory data fusion between the visual data extracted from the first image stream and telemetry data received from the first drone 202A and/or from the second drone 202B. For example, the drone remote control engine 220 may compute the speed of the second drone 202B based on a direction vector included in telemetry data received from the second drone 202B combined with a relative speed computed based on consecutive images (frames) of the first image stream. In another example, the drone remote control engine 220 may compute the altitude of the second drone 202B based on altitude information extracted from telemetry data of the first drone 202A combined with a relative height of the second drone 202B with respect to the drone 202A computed based on the visual data extracted from the first image stream.

Optionally, the drone remote control engine 220 may issue one or more alerts, either to the operator(s) 208 and/or to the other system(s) and/or service(s) relating to the operation of the drone 202B, for example, the UTM, in case the flight parameter(s) computed for the second drone 202B deviate from respective predefined flight parameters(s).

Optionally, the drone remote control engine 220 may compute the position (location) of the second drone 202B, for example, longitude, latitude, altitude and/or the like based on the position of the first drone 202 and a relative position of the second drone 202 with respect to the first drone 202A as derived from analysis of the first image stream. For example, the drone remote control engine 220 may obtain the position of the first drone 202A which may be captured and/or computed using one or more geolocation sensors of the first drone 202A, for example, a GNSS sensor such as, for example, GPS sensor and/or the like. The drone remote control engine 220 may further analyze one or more images of the first image captured from the first drone 202A to compute, as known in the art, a distance vector, i.e., angle and distance between the first drone 202A and the second drone 202B according to the known operational parameters of the imaging sensor(s) 214 of the first drone 202A which capture the first image stream. The drone remote control engine 220 may then compute an absolute position of the second drone 202B based on the absolute position of the first drone 202A and the relative position of the second drone 202B with respect to the first drone 202A.

Moreover, the drone remote control engine 220 may transmit the computed position of the second drone 202B to the second drone 220B. This may be applied to provide the second drone 202B with its position information, specifically, in case the second drone 202B is incapable of locally generating and/or obtaining reliable position information. For example, the second drone 202B may be located in a low GNSS (e.g. GPS) signal reception area which may prevent its local GNSS sensor(s) to compute its position. In another example, the geolocation sensor(s) of the second drone 202B may suffer malfunction and/or damage and may be therefore incapable of compute the position of the second drone 202B. Providing the second drone 202B with its computed position to replace its unavailable local position information may therefore enable the drone 202B to efficiently and accurately operate despite its failure to locally compute its position.

As stated herein before, the second drone 202B may be actively operated in case of emergency and/or malfunction experienced by the second 202B which may in some cases require operating the second drone 202B to an emergency landing. In such cases, the drone remote control engine 220 may optionally automatically analyze the first image stream and/or part thereof to identify one or more potential emergency landing sites where the malfunctioning second drone 202B may be landed. The drone remote control engine 220 may further analyze the first image stream to identify a route to one or more of the potential emergency landing site(s) and in particular to a selected potential emergency landing site. Moreover, the drone remote control engine 220 may be configured to analyze the first image stream to identify one or more objects and/or potential obstacles in one or more of the potential emergency landing sites and/or en route to them.

In some emergency and/or malfunction scenarios, rather than landing the second drone 202B at an emergency landing site, the second drone 202B may be instructed to drop to the ground, optionally after opening a parachute. However, the drop instruction may be issued only after, based on analysis of the first image stream, the remote control engine 220 indicates that the drop zone is clear (all clear) of one or more objects such as, for example, people, vehicles, structures, vegetation and/or the like. The drop instruction (command) may be issued in one or more emergency and/or malfunction scenarios in which it may be impossible to land the second drone 202B, for example, control of the second drone 202B is at least partially lost, no emergency landing site is identified and/or the like.

Assisted landing in which landing of one or more of the drones 202 may be supported, assisted and/or secured based on analysis of the images stream(s) captured by their companion drone 202 is not limited to emergency landing and may be also applied to assist landing drone(s) 202 which are in full control, i.e. not subject to any malfunction and/or emergency condition. For example, assuming the second drone 202B which is in full control, i.e., in no emergency or distress condition, is operated to land, whether automatically, manually and/or semi-automatically in a certain landing site. In such case, the image stream(s) captured by the companion first drone 202A may be analyzed, for example, by the drone remote control engine 220 to identify potential obstacles and/or hazards that may impose danger, threat and/or risk to the landing second drone 202B. Such obstacles which may be identified based on the analysis of the images stream(s) captured by the first drone 202A to depict the second drone 202B may include obstacles which may jeopardize the landing of the companion second drone 202B in the air en route to the landing site and/or on the ground at the landing site. Typically, one or more landings of one of the drones 202A and/or 202B may be managed according to a landing protocol. Assuming the drone 202B is landing, the landing protocol may define that the companion drone 202A of the landing drone 202B should escort the landing drone 202B using a predefined protocol that defines the position of the companion drone 202A relative to the landing drone 202B at every stage of the landing. Similarly, in case the drone 202A is landing, the companion drone 202B may apply the landing protocol and escort the landing drone 202A by flying and positioning itself relative to the position of the landing drone 202A at any time during the landing according to the predefined protocol.

The assisted landing may be further extended to assisted delivery in which one or more of the drones 202 delivering a package, for example, by lowering a cable while hovering above a delivery site, for example, a ground location, a rooftop, a balcony and/or the like. In such case, the delivering drone 202 may be supported, assisted and/or secured based on analysis of the image stream(s) captured by its companion drone(s) 202 to ensure that the package lowered from the delivering drone 202 and/or the cable extending from the delivering drone 202 do not collide, hit and/or endanger one or more objects and/or obstacles located at and/or near the delivery site. For example, assuming the second drone 202B delivers a package at a certain delivery site. In such case, the drone remote control engine 220 may analyze the image stream(s) captured by the companion first drone 202A to identify one or more potential obstacles en route to the delivery site and/or at the delivery site and may operate and/or instruct the second drone 202B to avoid collision with detected obstacles during the delivery process. Moreover, the remote control engine 220 may abort the delivery in case of risk, or danger of collision of the second drone 202B, the packaged and/or the cable lowering the package from the second drone 202B with one or more of the detected obstacle(s).

Moreover, one or more delivery processes of the drones 202A and/or 202B may be managed according to a delivery protocol in which the companion drone escorts the delivery drone using a predefined protocol that defines the position of the companion drone relative to the delivery drone at every stage of the delivery.

The drone remote control engine 220 may optionally generate one or more annotated image streams based on the analysis of the first image stream. The annotated image stream(s) may be used by one or more of the operator(s) 208 to operate and/or monitor the second drone 202B. One or more of the annotated image stream(s) may be stored for future use, for example, analysis, review, audit and/or the like.

The annotated image stream(s) may include additional visual data, for example, symbols, icons, bounding boxes, text and/or the like relating to one or more object identified in the first image stream. For example, a certain annotated image stream may include a bounding box encompassing the second drone 202B. In another example, a certain annotated image stream may include a symbol placed over the second drone 202B to designate the second drone 202B. In another example, a certain annotated image stream may include an ID of the second drone 202B. In another example, a certain annotated image stream may present one or more of the flight parameters of the second drone 202B, for example, the altitude, the speed and/or the like. In another example, a certain annotated image stream may present a line designating a route of the second drone 202B. In another example, a certain annotated image stream may include one or more bounding boxes encompassing one or more objects and/or potential obstacles detected in proximity to the second drone 202B.

In its highest automation level, the drone remote control engine 220 may operate automatically the second drone 202B based on the analysis of the first image stream. Specifically, the drone remote control engine 220 may actively and automatically operate the second drone 202B in case of emergency, malfunction and/or any other unexpected scenario while normally the second drone 202B may operate autonomously according to its predefined mission plan.

The drone remote control engine 220 may analyze the first image stream as described herein before, for example, detect objects and/or potential obstacles in the environment of the second drone 202B and their attributes, detect flight parameters of the second drone 202B and/or the like and may automatically operate the second drone 202B accordingly. Moreover, since the drone remote control engine 220 may actively operate the second drone 202B in case of emergency, malfunction and/or other unexpected situations, the drone remote control engine 220 may automatically operate the second drone 202B during one or more emergency landings. In such case, the drone remote control engine 220 may automatically land the second drone 202B in one of the potential landing site(s) identified based on the analysis of the first image stream and may further operate the second drone 202 to avoid potential obstacles detected at the selected landing site based on the analysis of the first image stream.

Optionally, the drone remote control engine 220 may dynamically adjust, in real-time (i.e., in flight time), one or more flight parameters of the first drone 202A and/or of the second drone 202B with respect to each other, for example, position, speed, altitude and/or the like according to one or more visibility attributes to maintain the VLOS between the first drone 202A and the second drone 202B. The visibility attributes may be imposed by one or more objects, obstacles, conditions and/or the like, for example, one or more objects potentially blocking the VLOS between the first drone 202A and second drone 202B, an environmental condition reducing visibility range and/or the like.

For example, assuming that, based on the analysis of the first image stream depicting the second drone 202B and/or analysis of the second image stream depicting the first drone 202A, the drone remote control engine 220 detects one or more objects potentially blocking the VLOS, for example, a building, a hill, a communication tower and/or the like. In such case, the drone remote control engine 220 may adjust the position of the first drone 202A and/or of the second drone 202B to ensure that VLOS between them is not blocked by the potentially blocking object(s), for example, elevate the first drone 202A and/or the second drone 202B, move the first drone 202A and/or the second drone 202B around the potentially blocking object(s) and/or the like.

In another example, assuming that, based on the analysis of the first image stream and/or analysis of the second image stream, the drone remote control engine 220 determines the visibility is low, for example, due to low illumination, fog and/or the like, the drone remote control engine 220 may adjust the position of the first drone 202A and/or of the second drone 202B to move them closer to each other thus maintaining clear VLOS between them.

Moreover, the drone remote control engine 220 may further operate the first drone 202A and/or the second drone 202B to track the second drone 202B around a center of the FOV of the imaging sensor(s) 214 of the first drone 202A capturing the first image stream thus capturing the second drone 202B substantially in the center of the images of the first image stream. This may be done to ensure that the surrounding of the second drone 202B are effectively seen in the first image stream in sufficient distances in all directions of the second drone 202B. This may be essential, since in case the second drone 202B is tracked at the edges of the first image stream (i.e., not centered), at least some areas in close proximity to the second drone 202B may not be effectively monitored for potential hazards, objects and/or obstacles.

Optionally, the drone remote control engine 220 may dynamically adjust the selected flight formation, for example, alter the flight formation, select another flight formation and/or the like to adjust the position of the first drone 202A and/or the position of the second drone 202B with respect to each other according to one or more of the at least one visibility attributes to maintain the line of sight between the first drone 202A and the second drone 202. This may be done, for example, in order to maximize the range of angles covered by both drones 202A and 202B for obstacle avoidance optimization, such that the rear drone 202 may look forward with its companion drone 202 in the center of its FOV and the front drone 202 may look backwards with its companion drone in the center of its FOV.

Optionally, the drone remote control engine 220 may dynamically adjust, in real-time, one or more flight parameters of the first drone 202A and/or the second drone 202B, for example, the route, the position, the altitude, the speed and/or the like to ensure that at least one of the first drone 202A and the second drone 202B have GNSS (e.g. GPS) signal. Specifically, the drone remote control engine 220 may dynamically adjust the flight parameter(s) of the first drone 202A and/or the second drone 202B in case the first drone 202A or the second drone 202B fly in a limited or no GNSS signal area. In such case, the drone remote control engine 220 may dynamically adjust one or more flight parameters of the first drone 202A and/or the second drone 202B to enable the companion drone 202, flying in an area in which the GNSS signal is available, to provide the drone 202 having no GNSS signal its computed position. The computed position may be computed as described herein before based on the position of the companion drone 202 as derived from its GNSS position data combined with the relative position of the drone 202 having no GNSS signal with respect to the companion drone 202.

For example, assuming the first drone 202A flies in a no GNSS signal area, for example, an indoor area (e.g. a stadium, etc.), next to a radiation source (e.g. a power distribution facility, etc.), next to a metal barrier and/or the like. The second drone 202B, however, flying in companion with the first drone 202A may fly in an area having good GNSS signal reception, for example, in an open unroofed section of the stadium, further away from the power distribution facility and/or the like. In such case the drone remote control engine 220 may dynamically adjust the position, speed, altitude and/or one or more other flight parameters of the first drone 202A and/or the second drone 202B to ensure that the second drone 202B may remain in GNSS signal available area(s) and may be operated to transmit the computed position of its companion first drone 202A to the first drone 202A. As such, the first drone 202A, having no local GNSS signal and thus unable to compute its position, may execute its assigned mission based on its computed position received from the second drone 202B.

Moreover, the drone remote control engine 220 may dynamically adjust, in real-time, one or more flight parameters of the first drone 202A and/or the second drone 202B to support visual navigation for at least one of the companion drone 202. Visual navigation is based on detecting and identifying salient landmarks and navigating accordingly compared to a planned route indicating these landmarks, optionally further using dead reckoning. As such, the drone remote control engine 220 may dynamically adjust the flight parameter(s) of the first drone 202A and/or the second drone 202B to ensure that at least one of the first drone 202A or the second drone 202B are capable to identify visual landmarks in their surrounding environment and apply visual navigation accordingly. For example, assuming the 202A is flying in low orbit and is incapable to detect salient landmarks on which it may rely for visually navigation. In such case, the drone remote control engine 220 may transmit to the drone 202A its computed position computed as described herein before based on the position of the companion drone 202B as derived from its GNSS position data and/or from its visual navigation combined with the relative position of the drone 202A with respect to its companion drone 202B.

As stated herein before, the drone remote control engine 220 may similarly operate the first drone 202A and/or the second drone 202B to track the first drone 202A around a center of the FOV of the imaging sensor(s) 214 of the second drone 202B capturing the second image stream thus capturing the first drone 202A substantially in the center of the images of the first image stream.

It should be noted that the operator(s) 208 may obviously manually operate the first drone 202A and/or the second drone 202B may to maintain the VLOS between them and/or to track them in the center of FOV based on analysis of the first and/or second image streams.

According to some embodiments of the present invention, groups of drones 202 may be selected automatically from a plurality of drones 202 each assigned a respective mission such that each group of drones 202 may be operated in missions extending BVLOS of the operator(s) 208 and/or remote control system(s) 204.

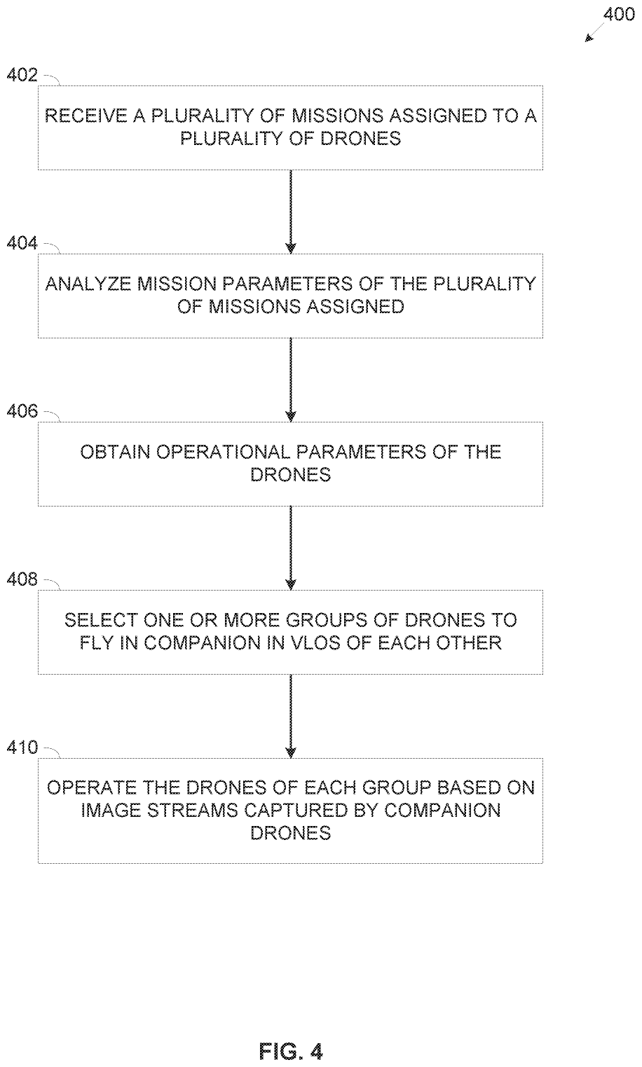

Reference is now made to FIG. 4, which is a flowchart of an exemplary process of selecting groups of drones for flying in companion in VLOS with each other and operating the group of drones according to image streams captured by companion drones, according to some embodiments of the present invention.

An exemplary process 400 may be executed for automatically selecting one or more groups of drones from a plurality of drones such as the drones 202 where each group may comprise two or more drones 202. The drones 202 may be grouped together in each group according to one or more mission parameters of their assigned mission, optionally coupled with one or more operational parameters of the drones 202.

Each group of drones 202 may be then operated BVLOS of one or more operators such as the operator 208 which may be stationed at a remote control system such as the remote control system 204 and/or at a remote server such as the remote server 212 to operate and/or monitor the drones 202. The drones 202 of each group may be operated manually, automatically and/or in a combination therefore as described herein before according to the process 100 executed by one or more remote control systems 204 and/or one or more remote servers 212.

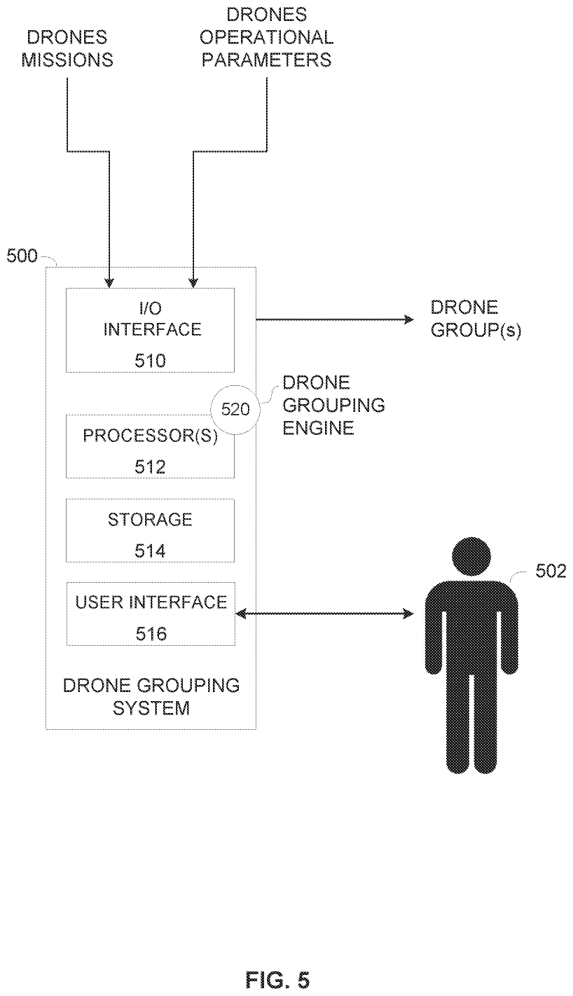

Reference is also made to FIG. 5, which is a schematic illustration of an exemplary system for selecting groups of drones for flying in companion in VLOS with each other and operating the group of drones according to image streams captured by companion drones, according to some embodiments of the present invention.

An exemplary drone grouping system 500, for example, a server, a computing node, a cluster of computing nodes and/or the like may include an I/O interface 510, a processor(s) 512 such as the processor(s) 224 for executing the process 400 and/or part thereof, and a storage 514 for storing data and/or program (program store).

The I/O interface 510 may include one or more interfaces and/or ports, for example, a network port, a USB port, a serial port and/or the like for connecting to one or more attachable devices, for example, a storage media device and/or the like. The I/O interface 510 may further include one or more wired and/or wireless network interfaces for connecting to a network such as the network 510 in order to communicate with one or more remote networked resources, for example, a remote control system 204, a remote server 212 and/or the like.

The processor(s) 512, homogenous or heterogeneous, may include one or more processors arranged for parallel processing, as clusters and/or as one or more multi core processor(s). The storage 514 may include one or more non-transitory persistent storage devices, for example, a Read Only Memory (ROM), a Flash array, a hard drive and/or the like. The storage 226 may also include one or more volatile devices, for example, a Random Access Memory (RAM) component, a cache memory and/or the like. The storage 514 may further include one or more network storage resources, for example, a storage server, a Network Attached Storage (NAS), a network drive, and/or the like accessible via one or more networks through the I/O interface 510.

The processor(s) 512 may execute one or more software modules such as, for example, a process, a script, an application, an agent, a utility, a tool, an OS and/or the like each comprising a plurality of program instructions stored in a non-transitory medium (program store) such as the storage 514 and executed by one or more processors such as the processor(s) 512. The processor(s) 512 may optionally integrate, utilize and/or facilitate one or more hardware elements (modules) integrated, utilized and/or otherwise available in the drone grouping system 500, for example, a circuit, a component, an IC, an ASIC, an FPGA, a DSP, a GPU, an AI accelerator and/or the like.

The processor(s) 512 may therefore execute one or more functional modules implemented using one or more software modules, one or more of the hardware modules and/or combination thereof, for example, a drone grouping engine 520 configured to execute the process 500 and/or part thereof.

Optionally, the drone grouping system 500, specifically the drone grouping engine 520 are provided and/or utilized by one or more cloud computing services, for example, Infrastructure as a Service (IaaS), Platform as a Service (PaaS), Software as a Service (SaaS) and/or the like provided by one or more cloud infrastructures, platforms and/or services such as, for example, Amazon Web Service (AWS), Google Cloud, Microsoft Azure and/or the like.

The drone grouping system 500 may optionally include a user interface 516 comprising one or more HMI interfaces for interacting with one or more users 502 to enable the user(S) 520 to intervene in grouping one or more of the drone groups, review the grouping and/or receive the drones grouping. The user interface 516 may therefore include, for example, a screen, a touch screen, a keyboard, a keypad, a pointing device (e.g., mouse, trackball, etc.), a speaker, a microphone and/or the like.

As shown at 402, the process 400 starts with the drone grouping engine 520 receiving a plurality of missions each associated with a respective one of a plurality of drones 202.

Each of the plurality of missions may be defined by one or more mission parameters, for example, a mission type (e.g. area monitoring, sensory and/or imagery data capturing, delivery, etc.), a geographical area in which the mission is carried out, a destination, a route, a duration, a schedule (e.g. start time, end time, etc.) and/or the like.

As shown at 404, the drone grouping engine 520 may analyze the mission parameters of each of the plurality of missions assigned to the plurality of drones 202 in order to determine the requirements of each assigned drone as derived from the mission parameters, for example, the destination of the respective drone 202, the geographical area in which the respective drone 202 will fly, a route the respective drone 202 needs to follow, one or more timing parameters for the respective drone 202 to carry out its assigned mission, for example, start time, end time, duration and//or the like.

As shown at 406, the drone grouping engine 520 may obtain one or more operational parameters of each of the plurality of drones 202 assigned to execute the plurality of missions.

The drone grouping engine 520 may obtain the operational parameters from one or more resources. For example, the drone grouping engine 520 may fetch the operational parameters from a locally stored record (e.g. list, table, file, database, etc.) stored in the drone grouping system 500, for example, in the storage 514. In another example, the drone grouping engine 520 may receive the operational parameters from one or more remote network resources via a network such as the network 210.

The operational parameters of each drone 202 may relate to the respective drone 202 itself, for example, a speed (e.g. maximal minimal, etc.), a flight range, an altitude (e.g. maximal minimal, etc.), a power consumption, a battery capacity and/or the like. The operational parameters of each drone 202 may further relate to one or more imaging sensors such as the imaging sensor 214 mounted, carried, integrated and/or otherwise coupled to the respective drone 202. Such operational parameters may include, for example, a resolution of the imaging sensor(s) 214, an FOV of the imaging sensor(s) 214, a range of the imaging sensor(s) 214, a zoom of the imaging sensor(s) 214 and/or the like.

As shown at 408, the drone grouping engine 520 may select one or more groups of drones where each group comprises two or more drones 202 that may be operated to execute their assigned missions while flying in companion in VLOS with each other.

Specifically, the drone grouping engine 520 may select the drones 202 to be grouped together based one or more of the mission parameters of the missions assigned to each of the drones 202 and further based on one or more of the operational parameters of the drones 202 in order to ensure that, while executing their respective missions, the grouped drones 202 may maintain VLOS with each other.

The drone grouping engine 520 may select a flight formation for each of the groups of drones 202 to enable the grouped drones 202 to maintain VLOS with each other. Moreover, the drone grouping engine 520 may optionally alter, adjust and/or modify one or more flight parameters, for example, the route, the speed, the altitude and/or the like of one or more of the drones 202 grouped together in order to ensure that the grouped drones 202 may maintain VLOS with each other.

For example, assuming that the drone grouping engine 520 identifies that several drones 202, for example three drones 202, are assigned missions which target a common geographical area, for example, a certain street and scheduled for substantially the same time, for example, within few minutes of each other. Further assuming that the drone grouping engine 520 identifies that the three drones 202 are capable of flying at substantially the same altitude at the same speed. In such case, the drone grouping engine 520 may group the three drones together to fly in a cyclic flight formation such that they may be operated to execute their assigned missions while flying in companion and maintaining VLOS with each other.

In another example, assuming that the drone grouping engine 520 identifies that one or more drones 202, for example five drones 202, are assigned delivery missions targeting a common geographical area, for example, a certain neighborhood while a sixth drone 202 is assigned an imagery data capturing mission in a geographical area comprising the certain neighborhood scheduled for time overlapping the time of the delivery missions. Further assuming that the drone grouping engine 520 identifies that the sixth drone 202 has high resolution high FOV imaging sensors 214 and is able to fly at high altitude such that the sixth drone 202 is capable of monitoring a very wide area covering the entire certain neighborhood. In such case, the drone grouping engine 520 may group the four drones 202 together, in particular, in a supervisor-subordinate formation such that the sixth drone 202 may maintain VLOS with each of the other five drones 202 while they execute their assigned delivery missions. Moreover, one or more of the five delivery drones 202 may be operated to maintain VLOS with the sixth drone 202 while executing its assigned imagery data capturing mission. The drone grouping engine 520 may optionally adjust the flight route, the position and/or the altitude of the sixth drone 202 such that during the time of flight of the five delivery drones 202, the sixth drone 202 may be in a position to maintain VLOS with the five delivery drones 202.

The drone grouping engine 520 may further select one or more of the groups of drones 202 to execute their assigned missions in companion in VLOS of each other according to one or more optimization criteria. The optimization criteria may include, for example, a minimal mission duration, an earliest mission completion, a minimal mission power consumption, a minimal mission cost, a minimal drone utilization, a minimal turn-around time for the next mission and/or the like.

For example, assuming that the drone grouping engine 520 identifies that a first drone 202 and a second drone 202 are assigned delivery missions targeting a common geographical area, for example, a certain street at a common first time while a third drone 202 is assigned a delivery mission targeting the same certain street at a second time. Further assuming that in a first scenario the drone grouping engine 520 is configured to group the drones 202 to achieve minimal mission cost. In such case, in order to reduce missions cost, the drone grouping engine 520 may group together the first, second and third drones 202 to execute their assigned delivery mission in companion at the first time, the second time and/or another time, for example, a third time between the first and second times. However, in a second scenario the drone grouping engine 520 may be configured to group the drones 202 to achieve an earliest mission completion (time). In this case, in order to complete the mission as soon as possible, the drone grouping engine 520 may group the together the first and second drones 202 to execute their assigned delivery mission in companion at the first time while grouping the third drone with another drone 202 not assigned a specific mission and especially operated in companion with the third drone 202 at the second time. Obviously, the group selection of the first scenario may significantly reduce the overall missions' cost and/or drone utilization while the groups selection of the second scenario may significantly expedite the completion of the missions and/or reduce the mission turn-around time, at least for the first and second drones 202.

As shown at 410, the grouped drones 202 of each group may be then operated to execute their assigned missions in companion in VLOS of each other. In particular, the done 202 of each group may be operated based on the image streams capture by the grouped drones 202 as described herein before in the process 100.

The drones 202 of each group may be operated in companion either manually by one or more of the operators 208 using the image streams captured by the grouped drones 202, semi-automatically based on analysis of the image streams by a drone remote control engine such as the drone remote control engine 220 and/or fully automatically by the drone remote control engine 220 based on the analysis of the image streams.

The drone grouping engine 520 may therefore send indication of the groups of drones 202 to one or more operators 208, one or more remote control systems 204, one or more remote servers 212 and/or a combination thereof which may operate the grouped drones 202 in companion. Optionally, the drone grouping engine 520 may integrate the drone remote control engine 220 and may be applied to support operation and/or operate automatically one or more of the groups of drones 202.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is expected that during the life of a patent maturing from this application many relevant systems, methods and computer programs will be developed and the scope of the terms drone, UAV. UAM, UTM, prediction algorithms and ML models are intended to include all such new technologies a priori.

As used herein the term “about” refers to +10%.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, an instance or an illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals there between.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

It is the intent of the applicant(s) that all publications, patents and patent applications referred to in this specification are to be incorporated in their entirety by reference into the specification, as if each individual publication, patent or patent application was specifically and individually noted when referenced that it is to be incorporated herein by reference. In addition, citation or identification of any reference in this application shall not be construed as an admission that such reference is available as prior art to the present invention. To the extent that section headings are used, they should not be construed as necessarily limiting. In addition, any priority document(s) of this application is/are hereby incorporated herein by reference in its/their entirety.

1. A computer implemented method of operating drones beyond visual line of sight (BVLOS), comprising:
receiving a first image stream captured by at least one imaging sensor mounted on a first drone and operated to monitor a companion second drone flying within visual line of sight of the first drone;
receiving a second image stream captured by at least one imaging sensor mounted on the second drone and operated to monitor the first drone flying within visual line of sight of the second drone;
operating the second drone based on analysis of the first image stream in which the second drone and its vicinity are continuously tracked; and
operating the first drone based on analysis of the second image stream in which the first drone and its vicinity are continuously tracked.

2-7. (canceled)

8. The computer implemented method of claim 16, further comprising generating at least one alert in response to detecting a deviation of the first drone and/or the second drone from a predefined route identified based on analysis of the second image stream and the first image stream respectively.

9. The computer implemented method of claim 8, further comprising transmitting correct route instructions to the deviating drone.

10. The computer implemented method of claim 1, further comprising generating at least one alert in response to detecting at least one malfunction to the first drone and/or the second drone detected in the second image stream and/or in the first image stream respectively.

11. (canceled)

12. The computer implemented method of claim 1, wherein the first drone and/or second drone are operated to avoid at least one obstacle in a potential collision course with the first drone and/or second drone based on analysis of the second image stream and/or in the first image stream respectively.

13. The computer implemented method of claim 12, further comprising generating at least one alert in response to detecting the at least one obstacle.

14. The computer implemented method of claim 12, wherein the first image stream and/or the second image stream are further analyzed to identify at least one attribute of the at least one obstacle, the at least one attribute is a member of a group consisting of: an obstacle type, a location, a velocity and a heading.

15. The computer implemented method of claim 1, further comprising assisting a landing of the first drone and/or the second drone at a landing site by analyzing a respective image stream depicting the landing drone and its vicinity to identify at least one potential obstacle en route to the landing site and/or in the landing site.

16. The computer implemented method of claim 1, further comprising managing at least one landing of the first drone and/or the second drone according to a landing protocol in which the landing drone is escorted by its companion drone using a predefined protocol defining a position of the companion drone relative to the landing drone at every stage of the landing.

17. The computer implemented method of claim 1, further comprising delivery of at least one package by the first drone and/or the second drone at a delivery site is assisted by analyzing a respective image stream depicting the delivering drone and its vicinity to identify at least one potential obstacle en route to the delivery site and/or at the delivery site.

18. (canceled)

19. The computer implemented method of claim 1, further comprising, responsive to detecting a malfunction condition to the first drone and/or second drone, automatically analyzing a respective image stream depicting the malfunctioning drone to identify at least one potential emergency landing site, and a route for the malfunctioning drone to a selected one of the at least one potential emergency landing site.

20. The computer implemented method of claim 19, further comprising operating the malfunctioning drone to open a parachute and drop in a drop zone after determining, based on analysis of the respective image stream, the drop zone is clear.

21. The computer implemented method of claim 1, further comprising dynamically adjusting a position of the first drone and/or the position of the second drone with respect to each other according to at least one visibility attribute to maintain the line of sight between the first drone and the second drone, the at least one visibility attribute is imposed by at least one of: an object potentially blocking the line of sight, and an environmental condition reducing visibility range.

22. The computer implemented method of claim 1, wherein the first drone and/or the at least one imaging sensor of the first drone are operated based on analysis of the first image stream to track the second drone around a center of a field of view (FOV) of the at least one imaging sensor of the first drone, and the second drone and/or the at least one imaging sensor of the second drone are operated based on analysis of the second image stream to track the first drone around a center of a FOV of the at least one imaging sensor of the second drone.

23-25. (canceled)

26. The computer implemented method of claim 1, further comprising computing a position of the first drone based on a position of the second drone and a relative position of the first drone with respect to the second drone as derived from analysis of the second image stream or vice versa computing a position of the second drone based on a position of the first drone and a relative position of the second drone with respect to the first drone as derived from analysis of the first image stream.

27. (canceled)

28. The computer implemented method of claim 26, further comprising dynamically adjusting a position of the first drone and/or the position of the second drone with respect to each other for at least one of:
ensuring at least one of the first drone and the second drone have global navigation satellite system (GNSS) signal, and
supporting visual navigation of at least one of the first drone and the second drone.

29. (canceled)

30. The computer implemented method of claim 1, further comprising computing at least one flight parameter of one of the first drone and/or the second drone derived from analysis of the second image stream and/or the first image stream respectively, the at least one flight parameter is a member of a group consisting of: a speed, an altitude, a direction, and an orientation.

31. (canceled)

32. The computer implemented method of claim 1, further comprising tracking the first drone and/or the second drone using at least one prediction algorithm applied to predict a position of the first drone and/or the second drone based on detection of the first drone and/or the second drone in periodically selected images of the second image stream and/or the first image stream respectively, the at least one prediction algorithm uses at least one machine learning (ML) model trained to predict the position of the first drone and/or of the second drone based on a flight pattern of the first drone and/or of the second drone respectively identified based on analysis of the second image stream and/or the first image stream respectively.

33. (canceled)

34. The computer implemented method of claim 1, further comprising the first drone is operated as a supervisor drone to monitor a plurality of subordinate drones and their vicinities, each of the plurality of subordinate drones is operated based on analysis of the first image stream captured by the at least one imaging sensor of the first drone in which the respective drone is continuously tracked, the first drone is operated based on analysis of at least one image stream captured by at least one imaging sensor mounted on at least one of the plurality of subordinate drones and operated to monitor the first drone.

35-36. (canceled)

37. A system for operating drones beyond visual line of sight (BVLOS), comprising:
at least one processor executing a code, the code comprising:
code instructions to receive a first image stream captured by at least one imaging sensor mounted on a first drone and operated to monitor a companion second drone flying within visual line of sight of the first drone;
code instructions to receive a second image stream captured by at least one imaging sensor mounted on the second drone and operated to monitor the first drone flying within visual line of sight of the second drone;
code instructions to operate the second drone based on analysis of the first image stream in which the second drone and its vicinity are continuously tracked; and
code instructions to operate the first drone based on analysis of the second image stream in which the first drone and its vicinity are continuously tracked.

38-42. (canceled)
